(19) United States
(12) Patent Application Publication
(10) Pub. No.: US 2023/0164872 A1
(43) Pub. Date: May 25, 2023

(54) COORDINATION FOR ACCESS LINK DISCONTINUOUS RECEPTION AND SIDELINK ALIGNMENT

(71) Applicant: QUALCOMM Incorporated, San Diego, CA (US)

(72) Inventors: Kaidong Wang, San Diego, CA (US); Jelena Damnjanovic, Del Mar, CA (US); Tao Luo, San Diego, CA (US); Qing Li, Princeton Junction, NJ (US); Sony Akkarakaran, Poway, CA (US); Aleksandar Damnjanovic, Del Mar, CA (US)

(21) Appl. No.: 17/535,401

(22) Filed: Nov. 24, 2021

(51) Int. Cl. H04W 76/28; H04W 4/12

(52) U.S. Cl. CPC H04W 76/28; H04W 4/12; H04W 92/18

(57) ABSTRACT

Methods, systems, and devices for wireless communications are described. In some wireless communications systems, a first base station or a base station component may receive an assistance information message associated with a sidelink discontinuous reception (DRX) configuration for communications between the first UE and a second UE. The first base station may transmit the assistance information message received from the first UE to a second base station or a second base station component. The first base station and the second base station may communicate with one another via a direct link or an interface, and the second base station may transmit an indication of the sidelink DRX configuration for the first UE to the first base station via the interface. The first base station may then transmit the sidelink DRX configuration to the first UE, along with an access link DRX configuration for the first UE.

### FIELD OF TECHNOLOGY

The following relates to wireless communications, including coordination during access link discontinuous reception and sidelink alignment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications devices may implement discontinuous reception (DRX) methods to conserve battery power, where the device cycles through periods of activity and inactivity according to a DRX periodicity. In some cases, however, multiple DRX configured devices may perform DRX alignment procedures to coordinate these periods of activity and inactivity.

### SUMMARY

The described techniques relate to improved methods, systems, devices, and apparatuses that support coordination during access link discontinuous reception (DRX) and sidelink alignment. Generally, the described techniques support techniques for sidelink DRX coordination. In some wireless communications systems, base stations may configure communications and alignment for user equipment (UE) operating in a DRX mode. For example, in cases where UEs communicate with one another using sidelink DRX communications, the UEs may perform DRX alignment so that an active time of one UE does not align with an active time of another UE. To support efficient DRX alignment and reduced sidelink signaling overhead, in some cases, a base station or base station component such as a centralized unit (CU) or a distributed unit (DU) may determine the DRX configurations and coordinate with one another via a direct link (e.g., an Xn or F1 interface) or a wired backhaul link. Such implementations may reduce power expenditure at the UE level, and free up sidelink resources that the UEs may use for transmitting data. In some cases, a UE may transmit assistance information to a base station, and the base station may use the assistance information to coordinate with a second base station to determine a sidelink DRX configuration for the UE and a second UE, along with an access link for the UE.

A method for wireless communication at a first base station is described. The method may include receiving, from a first UE, an assistance information message associated with a sidelink DRX configuration for communications between the first UE and a second UE, transmitting, to a second base station, the assistance information message received from the first UE, communicating, with the second base station via an interface between the first base station and the second base station, an indication of the sidelink DRX configuration for the first UE, and transmitting, to the first UE, an indication of the sidelink DRX configuration and an indication of an access link DRX configuration for the first UE based on the communicating.

An apparatus for wireless communication at a first base station is described. The apparatus may include a processor, memory coupled with the processor, and instructions stored in the memory. The instructions may be executable by the processor to cause the apparatus to receive, from a first UE, an assistance information message associated with a sidelink DRX configuration for communications between the first UE and a second UE, transmit, to a second base station, the assistance information message received from the first UE, communicate, with the second base station via an interface between the first base station and the second base station, an indication of the sidelink DRX configuration for the first UE, and transmit, to the first UE, an indication of the sidelink DRX configuration and an indication of an access link DRX configuration for the first UE based on the communicating.

Another apparatus for wireless communication at a first base station is described. The apparatus may include means for receiving, from a first UE, an assistance information message associated with a sidelink DRX configuration for communications between the first UE and a second UE, means for transmitting, to a second base station, the assistance information message received from the first UE, means for communicating, with the second base station via an interface between the first base station and the second base station, an indication of the sidelink DRX configuration for the first UE, and means for transmitting, to the first UE, an indication of the sidelink DRX configuration and an indication of an access link DRX configuration for the first UE based on the communicating.

A non-transitory computer-readable medium storing code for wireless communication at a first base station is described. The code may include instructions executable by a processor to receive, from a first UE, an assistance information message associated with a sidelink DRX configuration for communications between the first UE and a second UE, transmit, to a second base station, the assistance information message received from the first UE, communicate, with the second base station via an interface between the first base station and the second base station, an indication of the sidelink DRX configuration for the first UE, and transmit, to the first UE, an indication of the sidelink DRX configuration and an indication of an access link DRX configuration for the first UE based on the communicating.

In some examples of the method, apparatuses, and non-transitory computer-readable medium described herein, communicating with the second base station via the interface may include operations, features, means, or instructions for transmitting the assistance information message between the first base station and the second base station via a connection between a first CU of the first base station and a second CU of the second base station.

Some examples of the method, apparatuses, and non-transitory computer-readable medium described herein may further include operations, features, means, or instructions for relaying the indication of the sidelink DRX configuration and the indication of the access link DRX configuration from a first CU of the first base station to a first DU of the first base station and transmitting, to the first UE, the indication of the sidelink DRX configuration and the indication of the access link DRX configuration via an access link between the first UE and the first DU.

Some examples of the method, apparatuses, and non-transitory computer-readable medium described herein may further include operations, features, means, or instructions for transmitting the assistance information message to the second base station, the assistance information message including a field including one or more additional sidelink DRX configurations associated with one or more additional sidelink UEs, and a field including the indication of the access link DRX configuration for the first UE.

In some examples of the method, apparatuses, and non-transitory computer-readable medium described herein, the sidelink DRX configuration for the first UE includes one or more sidelink DRX alignment parameters.

In some examples of the method, apparatuses, and non-transitory computer-readable medium described herein, the access link DRX configuration for the second UE includes one or more access link DRX alignment parameters.

A method for wireless communication at a second base station is described. The method may include receiving, from a first base station, an assistance information message from a first UE, the assistance information message for determining a sidelink DRX configuration for communications between the first UE and a second UE, transmitting, to the first base station, an indication of the sidelink DRX configuration determined for the first UE via an interface between the first base station and the second base station, and transmitting, to the second UE, an indication of an access link DRX configuration for communications between the second UE and the second base station.

An apparatus for wireless communication at a second base station is described. The apparatus may include a processor, memory coupled with the processor, and instructions stored in the memory. The instructions may be executable by the processor to cause the apparatus to receive, from a first base station, an assistance information message from a first UE, the assistance information message for determining a sidelink DRX configuration for communications between the first UE and a second UE, transmit, to the first base station, an indication of the sidelink DRX configuration determined for the first UE via an interface between the first base station and the second base station, and transmit, to the second UE, an indication of an access link DRX configuration for communications between the second UE and the second base station.

Another apparatus for wireless communication at a second base station is described. The apparatus may include means for receiving, from a first base station, an assistance information message from a first UE, the assistance information message for determining a sidelink DRX configuration for communications between the first UE and a second UE, means for transmitting, to the first base station, an indication of the sidelink DRX configuration determined for the first UE via an interface between the first base station and the second base station, and means for transmitting, to the second UE, an indication of an access link DRX configuration for communications between the second UE and the second base station.

A non-transitory computer-readable medium storing code for wireless communication at a second base station is described. The code may include instructions executable by a processor to receive, from a first base station, an assistance information message from a first UE, the assistance information message for determining a sidelink DRX configuration for communications between the first UE and a second UE, transmit, to the first base station, an indication of the sidelink DRX configuration determined for the first UE via an interface between the first base station and the second base station, and transmit, to the second UE, an indication of an access link DRX configuration for communications between the second UE and the second base station.

In some examples of the method, apparatuses, and non-transitory computer-readable medium described herein, communicating with the first base station via the interface may include operations, features, means, or instructions for receiving the assistance information message from the first base station via a connection between a first CU of the first base station and a second CU of the second base station.

Some examples of the method, apparatuses, and non-transitory computer-readable medium described herein may further include operations, features, means, or instructions for determining the sidelink DRX configuration for the first UE and the access link DRX configuration for the second UE, transmitting, to the first base station, the indication of the sidelink DRX configuration for the first UE via the interface between the second base station and the first base station, and transmitting, to the second UE, the indication of the access link DRX configuration for the second UE based on the determining.

Some examples of the method, apparatuses, and non-transitory computer-readable medium described herein may further include operations, features, means, or instructions for receiving the assistance information message from the first base station, the assistance information message including a field including one or more additional sidelink DRX configurations associated with one or more additional sidelink UEs, and a field including the indication of the access link DRX configuration for the first UE.

In some examples of the method, apparatuses, and non-transitory computer-readable medium described herein, the sidelink DRX configuration for the first UE includes one or more sidelink DRX alignment parameters.

In some examples of the method, apparatuses, and non-transitory computer-readable medium described herein, the access link DRX configuration for the second UE includes one or more access link DRX alignment parameters.

A method for wireless communication is described. The method may include receiving, from a first UE, a first assistance information message at a first DU, the first assistance information message associated with a sidelink DRX configuration for communications between the first UE and a second UE, receiving, at a CU, the first assistance information message relayed by the first DU to the CU, communicating, between the CU and at least the first DU, an indication of the sidelink DRX configuration for the first UE and an indication of a first access link DRX configuration for the first UE, and transmitting, to the first UE, the indication of the sidelink DRX configuration and the indication of the first access link DRX configuration based on the communicating.

An apparatus for wireless communication is described. The apparatus may include a processor, memory coupled with the processor, and instructions stored in the memory. The instructions may be executable by the processor to cause the apparatus to receive, from a first UE, a first assistance information message at a first DU, the first assistance information message associated with a sidelink DRX configuration for communications between the first UE and a second UE, receive, at a CU, the first assistance information message relayed by the first DU to the CU, communicate, between the CU and at least the first DU, an indication of the sidelink DRX configuration for the first UE and an indication of a first access link DRX configuration for the first UE, and transmit, to the first UE, the indication of the sidelink DRX configuration and the indication of the first access link DRX configuration based on the communicating.

Another apparatus for wireless communication is described. The apparatus may include means for receiving, from a first UE, a first assistance information message at a first DU, the first assistance information message associated with a sidelink DRX configuration for communications between the first UE and a second UE, means for receiving, at a CU, the first assistance information message relayed by the first DU to the CU, means for communicating, between the CU and at least the first DU, an indication of the sidelink DRX configuration for the first UE and an indication of a first access link DRX configuration for the first UE, and means for transmitting, to the first UE, the indication of the sidelink DRX configuration and the indication of the first access link DRX configuration based on the communicating.

A non-transitory computer-readable medium storing code for wireless communication is described. The code may include instructions executable by a processor to receive, from a first UE, a first assistance information message at a first DU, the first assistance information message associated with a sidelink DRX configuration for communications between the first UE and a second UE, receive, at a CU, the first assistance information message relayed by the first DU to the CU, communicate, between the CU and at least the first DU, an indication of the sidelink DRX configuration for the first UE and an indication of a first access link DRX configuration for the first UE, and transmit, to the first UE, the indication of the sidelink DRX configuration and the indication of the first access link DRX configuration based on the communicating.

Some examples of the method, apparatuses, and non-transitory computer-readable medium described herein may further include operations, features, means, or instructions for receiving, from the second UE, a second assistance information message at a second DU, receiving, at the CU, the second assistance information message relayed by the second DU to the CU, communicating, between the CU and the second DU, an indication of a second access link DRX configuration for the second UE, and transmitting, to the second UE, the indication of the first access link DRX configuration based on the communicating.

Some examples of the method, apparatuses, and non-transitory computer-readable medium described herein may further include operations, features, means, or instructions for receiving, at the first DU and a second DU, one or more pre-configurations for determining one or more DRX configurations for the first UE and the second UE, transmitting, to the first UE via the first DU, the indication of the sidelink DRX configuration and the indication of the first access link DRX configuration based on the one or more pre-configurations, and transmitting, to the second UE via the second DU, an indication of a second access link DRX configuration based on the one or more pre-configurations.

Some examples of the method, apparatuses, and non-transitory computer-readable medium described herein may further include operations, features, means, or instructions for communicating, between the first DU and the second DU, the one or more DRX configurations for the first UE and the second UE based on the one or more pre-configurations.

Some examples of the method, apparatuses, and non-transitory computer-readable medium described herein may further include operations, features, means, or instructions for communicating, between the first DU and a second DU, the first assistance information message, the indication of the sidelink DRX configuration, the indication of the first access link DRX configuration, or any combination thereof.

In some examples of the method, apparatuses, and non-transitory computer-readable medium described herein, the CU determines the sidelink DRX configuration for the first UE, the first access link DRX configuration for the first UE, and the second access link DRX configuration for the second UE.

Some examples of the method, apparatuses, and non-transitory computer-readable medium described herein may further include operations, features, means, or instructions for receiving, from the second UE, a second assistance information message at the first DU, receiving, at the CU, the second assistance information message relayed by the first DU to the CU, communicating, between the CU and the first DU, an indication of a second access link DRX configuration for the second UE, and transmitting, to the second UE, the indication of the first access link DRX configuration based on the communicating.

Some examples of the method, apparatuses, and non-transitory computer-readable medium described herein may further include operations, features, means, or instructions for receiving, at the first DU, one or more pre-configurations for determining one or more DRX configurations for the first UE and the second UE, transmitting, to the first UE via the first DU, the indication of the sidelink DRX configuration and the indication of the first access link DRX configuration based on the one or more pre-configurations, and transmitting, to the second UE via the first DU, an indication of a second access link DRX configuration based on the one or more pre-configurations.

Some examples of the method, apparatuses, and non-transitory computer-readable medium described herein may further include operations, features, means, or instructions for communicating, between the CU and the first DU, the one or more DRX configurations for the first UE and the second UE based on the one or more pre-configurations.

Some examples of the method, apparatuses, and non-transitory computer-readable medium described herein may further include operations, features, means, or instructions for communicating, between the CU and the first DU and a second DU, the first assistance information message, the indication of the sidelink DRX configuration, the indication of the first access link DRX configuration, or any combination thereof.

In some examples of the method, apparatuses, and non-transitory computer-readable medium described herein, the first assistance information message includes one or more additional indications of sidelink connected mode DRX configurations established between the first UE and one or more other sidelink UEs.

Some examples of the method, apparatuses, and non-transitory computer-readable medium described herein may further include operations, features, means, or instructions for communicating via layer-1 signaling, layer-2 signaling, layer-3 signaling, or any combination thereof.

A method for wireless communication at a first UE is described. The method may include transmitting, to a base station, an assistance information message associated with a sidelink DRX configuration for communications between the first UE and a second UE, receiving, from the base station, an indication of the sidelink DRX configuration and an indication of an access link DRX configuration, communicating with the second UE via a sidelink in accordance with the received sidelink DRX configuration, and communicating with the base station via an access link in accordance with the received access link DRX configuration.

An apparatus for wireless communication at a first UE is described. The apparatus may include a processor, memory coupled with the processor, and instructions stored in the memory. The instructions may be executable by the processor to cause the apparatus to transmit, to a base station, an assistance information message associated with a sidelink DRX configuration for communications between the first UE and a second UE, receive, from the base station, an indication of the sidelink DRX configuration and an indication of an access link DRX configuration, communicate with the second UE via a sidelink in accordance with the received sidelink DRX configuration, and communicate with the base station via an access link in accordance with the received access link DRX configuration.

Another apparatus for wireless communication at a first UE is described. The apparatus may include means for transmitting, to a base station, an assistance information message associated with a sidelink DRX configuration for communications between the first UE and a second UE, means for receiving, from the base station, an indication of the sidelink DRX configuration and an indication of an access link DRX configuration, means for communicating with the second UE via a sidelink in accordance with the received sidelink DRX configuration, and means for communicating with the base station via an access link in accordance with the received access link DRX configuration.

A non-transitory computer-readable medium storing code for wireless communication at a first UE is described. The code may include instructions executable by a processor to transmit, to a base station, an assistance information message associated with a sidelink DRX configuration for communications between the first UE and a second UE, receive, from the base station, an indication of the sidelink DRX configuration and an indication of an access link DRX configuration, communicate with the second UE via a sidelink in accordance with the received sidelink DRX configuration, and communicate with the base station via an access link in accordance with the received access link DRX configuration.

Some examples of the method, apparatuses, and non-transitory computer-readable medium described herein may further include operations, features, means, or instructions for receiving, via a first DU of the base station, the indication of the sidelink DRX configuration and the indication of the access link DRX configuration based on one or more pre-configurations.

In some examples of the method, apparatuses, and non-transitory computer-readable medium described herein, transmitting the assistance information message may include operations, features, means, or instructions for transmitting the assistance information message via the access link to a first DU of the base station.

In some examples of the method, apparatuses, and non-transitory computer-readable medium described herein, the assistance information message includes one or more additional indications of sidelink connected mode DRX configurations established between the first UE and one or more other sidelink UEs.

Some examples of the method, apparatuses, and non-transitory computer-readable medium described herein may further include operations, features, means, or instructions for communicating via layer-1 signaling, layer-2 signaling, layer-3 signaling, or any combination thereof.

Some examples of the method, apparatuses, and non-transitory computer-readable medium described herein may further include operations, features, means, or instructions for refraining from transmitting the sidelink DRX configuration to the second UE based on receiving the indication of the sidelink DRX configuration from the base station.

### BRIEF DESCRIPTION OF THE DRAWINGS

FIGS. 1 through 3 illustrate example wireless communications systems that support coordination during access link discontinuous reception (DRX) and sidelink alignment in accordance with aspects of the present disclosure.

FIG. 4 illustrates an example of a process flow that supports coordination during access link DRX and sidelink alignment in accordance with aspects of the present disclosure.

FIG. 5 illustrates an example of a wireless communications system that supports coordination during access link DRX and sidelink alignment in accordance with aspects of the present disclosure.

FIGS. 6 and 7 illustrate example process flows that support coordination during access link DRX and sidelink alignment in accordance with aspects of the present disclosure.

FIG. 8 illustrates an example of a wireless communications system that supports coordination during access link DRX and sidelink alignment in accordance with aspects of the present disclosure.

FIGS. 9 and 10 illustrate example process flows that support coordination during access link DRX and sidelink alignment in accordance with aspects of the present disclosure.

FIGS. 11 and 12 show block diagrams of devices that support coordination during access link DRX and sidelink alignment in accordance with aspects of the present disclosure.

FIG. 13 shows a block diagram of a communications manager that supports coordination during access link DRX and sidelink alignment in accordance with aspects of the present disclosure.

FIG. 14 shows a diagram of a system including a device that supports coordination during access link DRX and sidelink alignment in accordance with aspects of the present disclosure.

FIGS. 15 and 16 show block diagrams of devices that support coordination during access link DRX and sidelink alignment in accordance with aspects of the present disclosure.

FIG. 17 shows a block diagram of a communications manager that supports coordination during access link DRX and sidelink alignment in accordance with aspects of the present disclosure.

FIG. 18 shows a diagram of a system including a device that supports coordination during access link DRX and sidelink alignment in accordance with aspects of the present disclosure.

FIGS. 19 through 24 show flowcharts illustrating methods that support coordination during access link DRX and sidelink alignment in accordance with aspects of the present disclosure.

### DETAILED DESCRIPTION

In some wireless communications systems, network devices such as base stations may communicate or share information to coordinate signaling between connected devices such as user equipment (UE). For example, base stations may configure communications and alignment for UEs operating in a discontinuous reception (DRX) mode. For example, in cases where UEs communicate with one another using sidelink DRX communications, the UEs may perform DRX alignment such that the sidelink grant from one of the UEs during its DRX active time does not overlap with the DRX active time of another UE. In some cases, the UEs may communicate with one another directly using sidelink resources, and with each respective base station in order to determine a sidelink DRX configuration that effectively coordinates the active DRX times. In some cases, however, this DRX alignment which relies on sidelink communications between the UEs may increase signaling overhead and power expenditure for the UEs.

To support more efficient DRX alignment and reduced sidelink signaling overhead, in some cases, a base station or base station component such as a centralized unit (CU) or a distributed unit (DU) may determine the DRX configurations and coordinate with one another via an Xn link or backhaul link. Such implementations may reduce power expenditure at the UE level, and free up sidelink resources that the UEs may use for transmitting data.

In some examples, a receiving UE and a transmitting UE may be connected to respective base stations via different CUs and DUs. The receiving UE may transmit assistance information to a first base station, and the first base station may relay the assistance information on to a second base station. The second base station then may determine a sidelink DRX configuration for the receiving UE, and transmits the configuration to the first base station, which then transmits the sidelink DRX configuration along with a Uu DRX configuration to the receiving UE. In such examples, the coordination of sidelink DRX configurations occurs between the first and second base stations, such that the base stations may exchange information directly via an Xn interface between them.

In some other examples, the receiving UE and the transmitting UE may be connected to different DUs, but a common CU. In such cases, the DUs may communicate indirectly between the CU to determine the sidelink DRX configuration, or the DUs may communicate directly between one another. In either case, the sidelink DRX configuration (and in some cases) the Uu DRX configuration is signaled between DUs, and transmitted to respective UEs. In some other examples, the receiving UE and the transmitting UE may be connected to a common CU and a common DU. In such cases, the assistance information provided by the receiving UE is used to determine sidelink DRX configurations and Uu configurations for the transmitting UE and the receiving UE by the CU.

Aspects of the disclosure are initially described in the context of wireless communications systems. Aspects of the disclosure are further illustrated by and described with reference to apparatus diagrams, system diagrams, process flows, and flowcharts that relate to coordination during access link DRX and sidelink alignment.

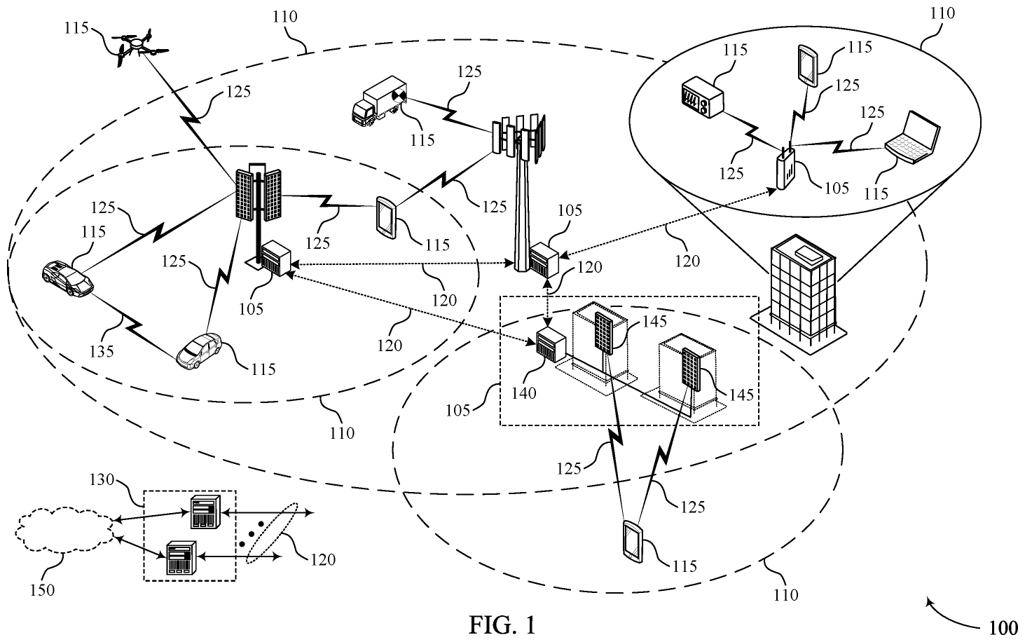

FIG. 1 illustrates an example of a wireless communications system 100 that supports coordination during access link DRX and sidelink alignment in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, in accordance with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some cases, a UE 115 may be configured for sidelink communications, and may receive a sidelink configuration message indicating a configuration for communicating via a sidelink or a PC5 link with another sidelink UE 115. For example, the sidelink configuration message may include a number of parameters related to the alignment of the sidelink transmissions, for example a DRX starting time offset parameter (e.g., sl-drx-StartOffset), a DRX cycle parameter (e.g., sl-drx-Cycle), and a DRX slot offset parameter (e.g., sl-drx-SlotOffset). In some examples, the sidelink DRX configuration (e.g., SL C-DRX configuration) may be transmitted via layer-3 signaling or via an RRC message. In some cases, the RRC message may contain the entire SL DRX configuration (e.g., using the sidelink RRC information element sl-DRX-Config), or the message may contain a subset of SL DRX configuration which is related to alignment (e.g., using the sidelink RRC information element sl-DRX-Config-Alignment). In addition, one or more parameters associated with the sidelink DRX configuration may be included in a MAC-CE for layer-2 signaling. For example, the MAC CE may include one or more sidelink DRX parameters such as various offset parameters and DRX cycle parameters (e.g., drx-StartOffset, sl-DRX-Cycle, sl-drx-SlotOffset). In some cases, the MAC CE format used to convey the sidelink DRX configuration may have variable length. Additionally or alternatively, the base station may indicate a subset of values for an update to the sidelink DRX configuration (e.g., a first parameter sl-drx-Slot-Offset has 32 values, and the base station may inform the UEs that the updated value in the MAC CE is one of 8 values in a subset). In such cases, the base station may use layer 3 signaling (e.g., RRC) to configure a set of values for various parameters in the sidelink DRX configuration, and then may use layer 1/layer 2 signaling to indicate one of the parameters. In some examples, sidelink DRX configuration messages may be transmitted between serving base stations (e.g., via an Xn interface) to reduce sidelink signaling overhead for the two sidelink UEs.

In some examples, a receiving UE 115 may have a sidelink connection with multiple transmitting UEs 115, and each transmitting UE 115 may set a different sidelink DRX configuration for the receiving UE 115. For example, the transmitting UE 115 may set the sidelink DRX configuration based on existing sidelink DRX configurations and capabilities of the receiving UE 115. In cases that the receiving UE 115 cannot monitor signaling or messaging from different transmitting UEs 115 simultaneously, the active times of each SL DRX may not overlap (works on FR2 and single panel). If the receiving UE 115 may monitor the signaling or messaging from different transmitting UEs 115 simultaneously, the active times of different SL DRX configurations may overlap (works on FR1 or multiple panels).

The wireless communications system 100 may support layer-3 signaling (e.g., RRC signaling) of existing sidelink C-DRX configurations from other transmitting UEs 115. In some examples, the sidelink configuration signaling may include the whole sidelink DRX configuration, or the sidelink configuration signaling may include parameters related to sidelink alignment.

In addition, a UE 115 may be configured to communicate via a direct link with a base station 105, for example, via a Uu link. The UE 115 may receive a Uu DRX configuration message indicating a configuration for communicating via an access link or a Uu link with the base station 105-a. For example, the Uu DRX configuration message may include a number of parameters related to the alignment of the transmissions on the access link, for example a DRX starting time offset parameter (e.g., drx-LongCycleStartOffset), a number of DRX parameters associated with DRX cycle length (e.g., shortDRX, drx-ShortCycle, drx-ShortCycleTimer), and a DRX slot offset parameter (e.g., drx-SlotOffset). In some examples, the Uu DRX configuration (e.g., Uu C-DRX configuration) may be transmitted in layer-3 signaling or via an RRC message. In some cases, the RRC message may contain the entire DRX configuration (e.g., using the sidelink RRC information element DRX-Config), or the message may contain a subset of DRX configuration which is related to alignment (e.g., using the sidelink RRC information element DRX-Config-Alignment). In addition, one or more parameters associated with the Uu DRX configuration may be included in a MAC-CE for layer-2 signaling. For example, the MAC CE may include one or more Uu DRX parameters such as various offset parameters and DRX cycle parameters (e.g., drx-LongCycleStartOffset, DRX-Short-Cycle, drx-SlotOffset). In some cases, the MAC CE format used to convey the sidelink DRX configuration may have variable length. Additionally or alternatively, the base station may indicate a subset of values for an update to the DRX configuration (e.g., a first parameter drx-Slot-Offset has 32 values, and the base station may inform the UEs that the updated value in the MAC CE is one of 8 values in a subset). In such cases, the base station may use layer 3 signaling (e.g., RRC) to configure a set of values for various parameters in the sidelink DRX configuration, and then may use layer 1/layer 2 signaling to indicate one of the parameters. In some examples, the DRX configuration messages may be transmitted between serving base stations (e.g., via an Xn interface) to reduce sidelink signaling overhead for the two UEs.

In some wireless communications systems, base stations 105 may configure communications and alignment for UEs 115 operating in a DRX mode. For example, in cases where UEs 115 communicate with one another using sidelink DRX communications, the UEs may perform DRX alignment so that an active time of one UE 115 does not align with an active time of another UE 115. In some cases, the UEs 115 may communicate with one another directly using sidelink resources, and with each respective base station 105 in order to determine a sidelink DRX configuration that effectively coordinates the active DRX times. In some cases, however, this DRX alignment which relies on sidelink communications between the UEs may increase signaling overhead and power expenditure

To support more efficient DRX alignment and reduced sidelink signaling overhead, in some cases, a base station 105 or base station component such as a CU or a DU may determine the DRX configurations and coordinate with one another via an Xn link or backhaul link. Such implementations may reduce power expenditure at the UE level, and free up sidelink resources that the UEs 115 may use for transmitting data.

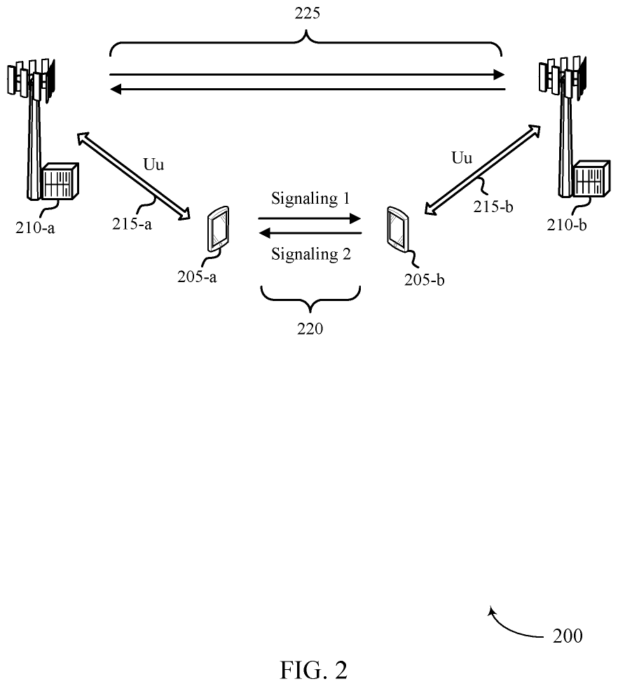

FIG. 2 illustrates an example of a wireless communications system 200 that supports coordination during access link DRX and sidelink alignment in accordance with aspects of the present disclosure. For example, wireless communications system 200 may support signaling between a UE 205-a, a UE 205-b, a base station 210-a, a base station 210-b, or any combination thereof.

In some wireless communications systems, base stations 210 (e.g., gNBs) may communicate or share information in order to coordinate signaling between connected devices in the network. For example, base stations 210 may configure communications for UEs 205 operating in a DRX mode (e.g., an idle mode DRX or connected mode DRX), and may perform various alignments for DRX operations between UEs 205. For example, the UE 205-a may communicate with the base station 210-a using a first access link (e.g., Uu link 215-a), and the UE 205-b may communicate with the base station 210-b using a second access link (e.g., Uu link 215-b). In addition, the UEs 205-a and 205-b may communicate with one another using sidelink signaling 220. In order to communicate via sidelink DRX, the UEs 205 may perform alignment so that the sidelink grant from one of the UEs 205 during a Uu active time does not overlap with the active time of the other UE 205. In some cases, the UE 205-a and the UE 205-b may communicate directly with one another using sidelink resources, and with each respective base station 210 in order to determine a sidelink DRX configuration. In some cases, however, this DRX alignment which relies on sidelink communications between the UEs 205-a and 205-b may increase signaling overhead and power expenditure for the UEs.

To support more efficient DRX alignment and reduced sidelink signaling overhead, in some cases, a base station or base station component may determine the DRX configurations and coordinate with one another via an Xn link 225 or backhaul link. Such implementations may reduce power expenditure at the UE level, and free up sidelink resources that the UEs 205 may use for transmitting data.

In some examples, the UE 205-a (e.g., a receiving UE) and the UE 205-b (e.g., a transmitting UE) may be connected to base stations 210-a and 210-b, respectively, with different CUs and different DUs. The UE 205-a may transmit assistance information to the base station 210-a, which the base station 210-a may send to the base station 210-b. The base station 210-b then determines a sidelink DRX configuration for the UE 205-a, and transmits the configuration to the base station 210-a, which then transmits the sidelink DRX configuration along with a Uu DRX configuration to the UE 205-a. The coordination of sidelink DRX configurations occurs between base stations, where the base stations 210-a and 210-b may exchange information directly via an Xn interface 225 between them.

In some other examples, the UE 205-a and the UE 205-b may be connected to different DUs, but a common CU. In such cases, the DUs may communicate indirectly between the CU to determine the sidelink DRX configuration, or the DUs may communicate directly between one another. In either case, the sidelink DRX configuration (and in some cases) the Uu DRX configuration is signaled between DUs, and transmitted to respective UEs.

In some other examples, the UE 205-a and the UE 205-b may be connected to a common CU and a common DU. In such cases, the assistance information provided by the UE 205-a is used to determine sidelink DRX configurations and Uu configurations for the UE 205-b and the UE 205-b at the CU.

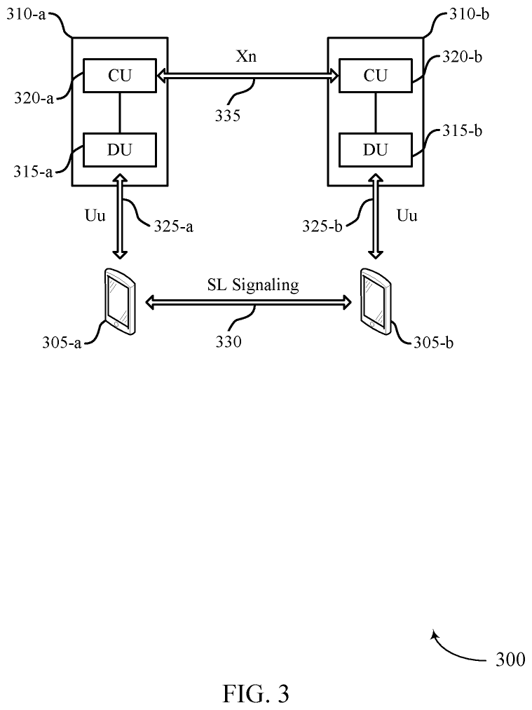

FIG. 3 illustrates an example of a wireless communications system 300 that supports coordination during access link DRX and sidelink alignment in accordance with aspects of the present disclosure. For example, wireless communications system 300 may support a signaling configuration in which one or more wireless user devices (such as a UE 305-a and UE 305-b) are connected to or otherwise associated with two different DUs and two different CUs of two different base stations (e.g., gNodeBs) such as base stations 310-a and 310-b. The base station 310-a may include a CU 320-a and a DU 315-a, and the base station 310-b may include a CU 320-b and a DU 315-b. The UEs 305-a and 305-b, along with the base station 310-a and 310-b may be examples of corresponding devices described with reference to FIGS. 1 and 2.

In some examples, the UE 305-a may be a transmitting UE (e.g., a Tx UE) and the UE 305-b may be a receiving UE (e.g., a Rx UE). The transmitting UE 305-a may be connected to the base station 310-a via the DU 315-a, and the receiving UE 305-b may be connected to the base station 310-b via the DU 315-b. The UEs 305-a and 305-b may be connected with each respective DU 315-a and 315-b using a Uu interface 325-a and 325-b, which may serve as direct links between the UEs 305 and each respective base station 310. In addition, the DU 305-b may be associated with a CU 320-a, and the DU 305-b may be associated with the CU 320-b. Devices in wireless communications system 300 may communicate via direct links (e.g., access links) or sidelinks. For example, the UEs 305 may communicate with the base stations 310 using direct links or Uu links 325, or the UEs may communicate with one another using sidelink signaling on the sidelink 330. In some cases, the sidelink signaling may occur via a PC5 interface between UEs 305. Additionally or alternatively, the base stations 310 may communicate with one another using a direct link or via the Xn interface 335

In some implementations, the UE 305-a and the UE 305-b may exchange sidelink information such as sidelink DRX configuration information via the sidelink signaling 330. In some cases, however, the configuration signaling may occupy a relatively large number of wireless resources between the UE 305-a and the UE 305-b, and may increase sidelink signaling overhead. To reduce such signaling overhead for the sidelink 330, in some examples, the base station 310-a and the base station 310-b may communicate directly via an Xn interface 330 to exchange the sidelink DRX information for the UEs 305-a and 305-b, which may reduce the signaling overhead and increase throughput for sidelink communications between the UEs 305-a and 305-b. For example, the base station 310-a and the base station 310-b may use the Xn interface 330 to exchange information directly (e.g., sidelink DRX information, Uu configuration information, etc.) between CUs without involving communications between user devices. In some examples, communications between the base stations on the Xn interface 330 may be performed through wired (e.g., an IAB connected) communications.

To facilitate sidelink alignment between UE 305-a and UE 305-b, the base station 310-b may receive assistance information from the receiving UE 305-b which includes a Uu DRX configuration of the receiving UE 305-b. Additionally or alternatively, the assistance information from the receiving UE 305-b may include additional sidelink DRX configurations of receiving UE 305-b with transmitting UE 305-a, or other existing sidelink DRX configurations of receiving UE 305-b with other transmitting UEs. The base station 310-b may transmit the assistance information it receives from the receiving UE 305-b to the base station 310-a via the Xn interface 335, and the base station 310-a may determine the receiving UE's sidelink DRX configuration, which it may transmit to the base station 310-b via the Xn interface. The base station 310-b may then relay the sidelink DRX configuration to the receiving UE 305-b. In such examples, the receiving UE 305-b may receive the sidelink DRX configuration (for configuring sidelink communications between itself and the transmitting UE 305-a), without directly communicating with the transmitting UE 305-a.

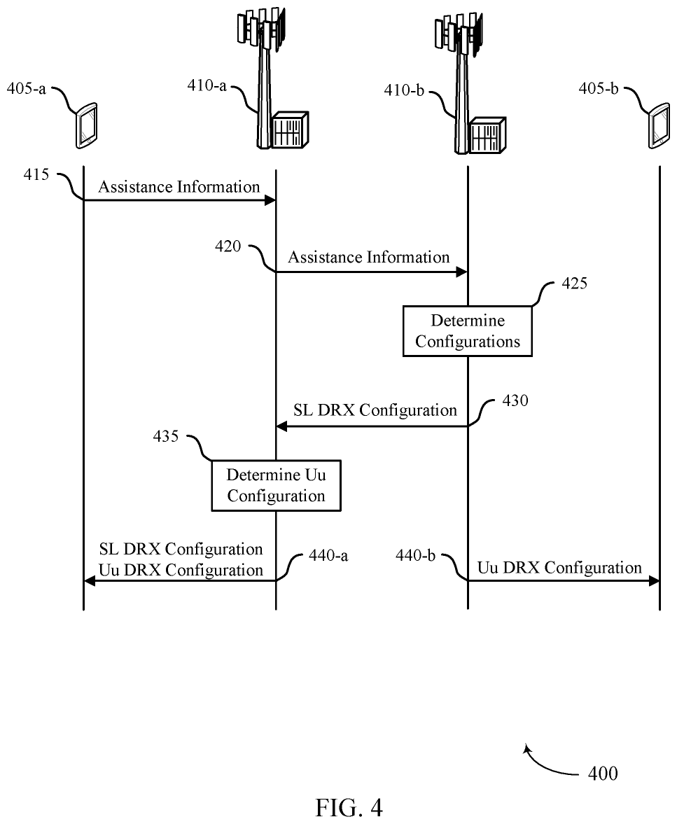

FIG. 4 illustrates an example of a process flow 400 that supports coordination during access link DRX and sidelink alignment in accordance with aspects of the present disclosure. The process flow 400 may implement aspects of wireless communications systems 100 through 300, or may be implemented by aspects of the wireless communications system 100 through 300. For example, the process flow 400 may illustrate operations between a UE 405-a, a UE 405-b, a base station 410-a and a base station 410-b, which may be examples of corresponding devices described with reference to FIGS. 1 and 2. In the following description of the process flow 400, the operations between the devices may be transmitted in a different order than the example order shown, or the operations may be performed in different orders or at different times or by different devices. Additionally or alternatively, some operations may also be omitted from the process flow 400, and other operations may be added to the process flow 400.

At 415, the receiving UE 405-a may transmit or report assistance information to the base station 410-a which is associated with the receiving UE 405-a. In some examples, the assistance information may include information which is unknown to the base station 410-a. For example, the assistance information may include existing SL DRX (e.g., C-DRX) configurations of receiving UE 405-a with other transmitting UEs. In such examples, the assistance information may provide information which allows the base station 410-a to select a configuration (e.g., a SL C-DRX configuration) that does not overlap with existing configurations used by the receiving UE 405-a or by other UEs in the system. The assistance information may optionally include a Uu DRX configuration between the receiving UE 405-a and the base station 410-a, but in some cases, the base station 410-a may know the Uu DRX configuration for the UE 405-a without the assistance information.

At 420, the base station 410-a may transmit the assistance information received from the receiving UE 405-a to the base station 410-b. In some examples, the signaling may be performed through wired (e.g., an IAB connection) communications. In some examples, the communication of assistance information between base stations may occur via an Xn interface between two CUs of the base stations. The assistance information may include the information transmitted to base station 410-a at 415 by receiving UE 405-a, such as existing SL C-DRX configurations of receiving UE 405-a, and may further include one or more additional information fields. In some cases, this information may allow the base station 410-b to select sidelink DRX configurations for the receiving UE 405-a that do not overlap with these existing sidelink configurations. The assistance information may further include the Uu DRX configuration of the receiving UE 405-a, which may be a connected mode DRX (C-DRX) or idle mode DRX (I-DRX) configuration. Since the Uu DRX configuration of receiving UE 405-a is known to base station 410-a, when preparing the assistance information to send to the base station 410-b, the base station 410-a may append the Uu DRX configuration to the assistance information received from the receiving UE 405-a.

At 425, the base station 410-b may determine DRX configurations for the receiving UE 405-a and for the transmitting UE 405-b. The base station 410-b may determine the DRX configurations based on the assistance information received from base station 410-a. The configurations determined by the base station 410-b may include a sidelink DRX configuration (e.g., SL C-DRX or I-DRX) for the receiving UE 405-a to use in communications with transmitting UE 405-b. The base station 410-b may select the sidelink DRX configuration such that the sidelink communications between the UE 405-a and the UE 405-b do not overlap with existing sidelink C DRX configurations configured for the receiving UE 405-a and other transmitting UEs. For example, if the receiving UE 405-a does not have the capability to monitor signaling from different transmitting UEs simultaneously, then the base station 410-b may coordinate the sidelink configurations such that the active times of each SL DRX do not overlap with each other. Additionally or alternatively, the base station 410-b may select a sidelink configuration (e.g., SL C-DRX or I-DRX) that is aligned with the Uu DRX configuration of receiving UE 405-a by including sidelink DRX parameters related to the alignment. For example, some alignment parameters may include sl-drx-StartOffset, sl-drx-Cycle, and sl-drx-SlotOffset. The selection of the SL DRX configuration may be facilitated by the assistance information received from base station 410-a. In addition, the base station 410-b may determine one or more configurations (such as a Uu DRX configuration) for the transmitting UE 405-b to use in communications with base station 410-b. In such cases, the configurations for the transmitting UE 405-b may be aligned with the configurations determined for the receiving UE 405-a. For example, the configurations may support coordinated communications between the UE 405-a and 405-b, such that the configurations support signaling that does not overlap or otherwise interfere.

At 430, the base station 410-b may transmit the determined SL DRX configuration (for the UE 405-a) to base station 410-a via a direct link between the base station 410-a and 410-b (e.g., via the Xn interface). In some examples, the signaling may be performed through wired (e.g., an IAB connection) communications between the base station 410-a and 410-b.

At 435, the base station 410-a may determine a Uu configuration for receiving UE 405-a to use in communications with base station 410-a. In some examples, the base station 410-a may use the assistance information received from receiving UE 405-a at 415 to determine the Uu configuration.

At 440-a, the base station 410-a may transmit the SL DRX configuration determined by the base station 410-b and the Uu DRX configuration determined by the base station 410-a to the receiving UE 405-a.

At 440-b, the base station 410-b may transmit the Uu DRX configuration determined by the base station 410-b to the transmitting UE 405-b.

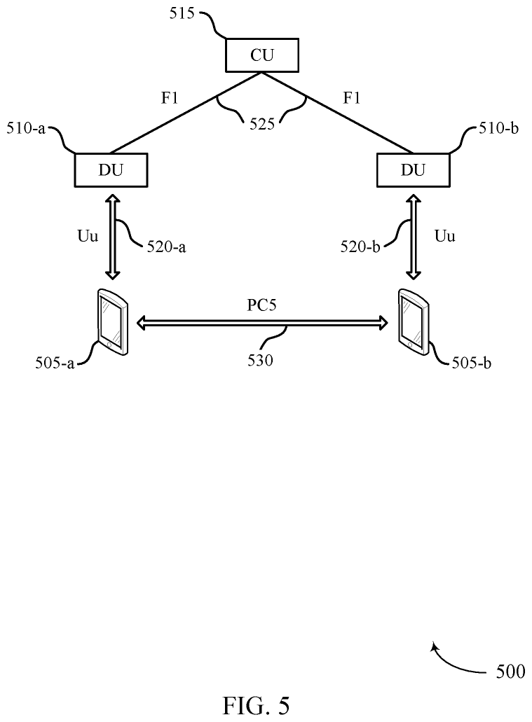

FIG. 5 illustrates an example of a wireless communications system 500 that supports coordination during access link DRX and sidelink alignment in accordance with aspects of the present disclosure. For example, the wireless communication system 500 may include communications between a UE 505-a, a UE 505-b a DU 510-a, a DU 510-b, and a CU 515. Wireless communications system 500 may also support a configuration in which transmitting and a receiving user devices such as UE 505 are associated with two different DUs and each associated with the same CU. In some examples, the DUs and CU may form part of a single base station (e.g., gNB) or different base stations.

The DU 510-a may be associated with or connected to a transmitting UE 505-a, and the UE 505-a and the DU 510-a may exchange information through the Uu interface 520-a. The DU 510-b may be associated with or otherwise connected to a receiving UE 505-b, and the UE 505-b and the DU 510-b may exchange information through the Uu interface 520-b.

In wireless communications system 500, the CU 515 and DU 510-b may communicate with the DU 510-a and DU 510-b through an F1 interface 525, which may be an example on an Xn interface or a direct link between base stations or base station components as described herein. In some cases, the Xn interface 525 may allow the CU 515 to directly exchange information with DU 510-a and DU 510-b without involving communications between user devices on the sidelink or PC5 link 530. For example, the direct communication between DUs 510-a and 510-b may allow the wireless communication system 500 to avoid using sidelink signaling 530 for exchanging sidelink or Uu link configuration information.

The DU 510-a, the DU 510-b, and the CU 515 may transmit additional signaling via the Xn interface 525 to further facilitate alignment between devices or device components. For example, this additional signaling may include assistance information carrying Uu DRX configuration of the receiving UE 505-b, the sidelink DRX configuration of receiving UE 505-b with transmitting UE 505-a, and other existing SL DRX configurations of receiving UE 505-b with other transmitting UEs.

In some cases, the DU 510-a and the DU 510-b may coordinate with one another in order to support communications between the UEs 505-a and 505-b. For example, in some cases, the DU 510-a and 510-b may communicate indirectly through the CU 515. In such examples, the DU 510-a and the DU 510-b may transmit information to the CU 515, and the CU 515 may use the information from each DU to coordinate and determine DRX configurations for the DUs. In some other examples, the DUs 510-a and 510-b may communicate directly between one another. In such examples, the CU 515 may transmit one or more pre-configurations to the DUs 510-a and 510-b, and the DUs 510-a and 510-b may determine respective DRX configurations for UEs 505-a and 505-b using the pre-configurations received from the CU. In some cases, if the pre-configurations are unsuccessful, the DUs 510-a and 510-b may communicate directly through the CU 515.

The direct or indirect communication between DUs 510-a may include the transmission of assistance information (e.g., including assistance information received from one or more connected UEs, among other information), and one or more sidelink DRX or Uu DRX configurations for the UE 505-a.

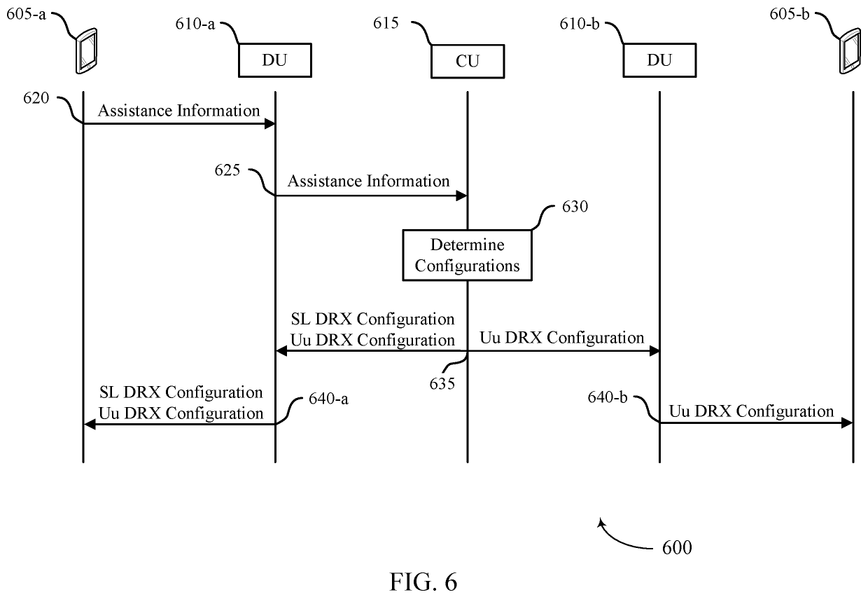

FIG. 6 illustrates an example of a process flow 600 that supports coordination during access link DRX and sidelink alignment in accordance with aspects of the present disclosure. The process flow 600 may implement aspects of wireless communications systems 100, 200, and 500, or may be implemented by aspects of the wireless communications systems 100, 200, and 500. For example, the process flow 400 may illustrate operations between a UE 605-a, a UE 605-b, a CU 615, a DU 610-a, and a DU 610-b, which may be examples of corresponding devices described with reference to FIGS. 1, 2, and 5. In the following description of the process flow 600, the operations between the devices may be transmitted in a different order than the example order shown, or the operations may be performed in different orders or at different times or by different devices. Additionally or alternatively, some operations may also be omitted from the process flow 600, and other operations may be added to the process flow 600. In some examples, process flow 600 may illustrate indirect communication between DUs 610-a and 610-b via the CU 615.

At 620, the receiving UE 605-a may transmit assistance information to the DU 610-a (e.g., the DU that is associated with or otherwise connected to the receiving UE 605-a). The assistance information may include information that is unknown to the DU 610-a that the DU 610-a may use for determining DRX configurations for UEs 605-a and 605-b. For example, the assistance information may include existing sidelink DRX (e.g., C-DRX, I-DRX) configurations established or configured at the receiving UE 605-a with other transmitting UEs.

At 625, the DU 610-a may transmit the assistance information to the CU 615 (e.g., the CU which is connected with both the DU 610-a and a DU 610-b). The assistance information may include information transmitted to DU 610-a at 620 by receiving UE 605-a, such as existing sidelink C-DRX configurations of receiving UE 605-a with other transmitting UEs. Since the Uu DRX configuration of receiving UE 605-a is known to base station 610-a, it may also include the Uu DRX configuration with the assistance information received from the receiving UE 605-a.

At 630, the CU 615 may determine DRX configurations for receiving UE 605-a and transmitting UE 605-b. For example, the CU 615 may determine the DRX configurations based on the assistance information received from DU 610-a. The determined configurations may include a sidelink DRX configuration (e.g., SL C-DRX) for the receiving UE 605-a to use in communications with transmitting UE 605-b. The CU 615 may ensure the selected SL DRX configuration does not overlap with existing SL C-DRX configurations from receiving UE 605-a with other transmitting UEs. For example, if the receiving UE 605-a does not have the capability to monitor signaling from different transmitting UEs simultaneously, then the CU 615 may determine the sidelink configuration such that the active times of each SL DRX do not overlap with each other. The CU 615 may also select a sidelink configuration (e.g., SL C-DRX) that is aligned with the Uu DRX configuration of receiving UE 605-a by including sidelink DRX parameters related to the alignment. These parameters may include sl-drx-StartOffset, sl-drx-Cycle, and sl-drx-SlotOffset, for example. In addition, the CU 615 may determine one or more configurations (such as a Uu DRX configuration) for the transmitting UE 605-b to use in communications with DU 610-b. In such cases, the configurations for the transmitting UE 605-b may be aligned with the configurations determined for the receiving UE 605-a. For example, the configurations may support coordinated communications between the UE 610-a and 605-b, such that the configurations support signaling that does not overlap or otherwise interfere.

At 635, the CU 615 may transmit the determined sidelink DRX configuration and the Uu DRX configuration for the receiving UE 605-a to the DU 610-a, and may transmit the determined Uu configuration for transmitting UE 605-b to DU 610-b.

At 640-a, the DU 610-a may transmit the sidelink DRX configuration and the Uu DRX configuration determined by the CU 615 to the receiving UE 605-a.

At 640-b, the DU 610-b may transmit the Uu DRX configuration determined by the CU 615 to transmitting UE 605-b. As described in FIG. 6, the indirect communication between DUs 610-a and 610-b through CU 615 may reduce excess signaling and resource usage between UEs 605-a and 605-b communicating via sidelink DRX.

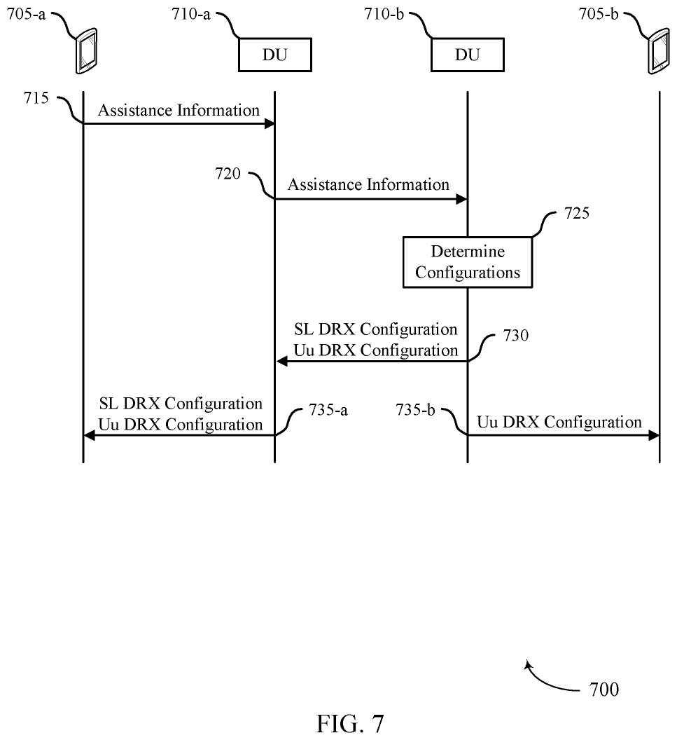

FIG. 7 illustrates an example of a process flow 700 that supports coordination during access link DRX and sidelink alignment in accordance with aspects of the present disclosure. The process flow 700 may implement aspects of wireless communications systems 100, 200, and 500, or may be implemented by aspects of the wireless communications systems 100, 200, and 500. For example, the process flow 700 may illustrate operations between a UE 705-a, a UE 705-b, a DU 710-a, and a DU 710-b, which may be examples of corresponding devices described with reference to FIGS. 1, 2, and 5. In the following description of the process flow 700, the operations between the devices may be transmitted in a different order than the example order shown, or the operations may be performed in different orders or at different times or by different devices. Additionally or alternatively, some operations may also be omitted from the process flow 700, and other operations may be added to the process flow 700. In some examples, process flow 700 may illustrate direct communication between DUs 710-a and 710-b.

At 715, the receiving UE 705-a may transmit assistance information to the DU 710-a (e.g., the DU that is associated with or otherwise connected to the receiving UE 705-a). The assistance information may include information that is unknown to the DU 710-a that the DU 710-a may use for determining DRX configurations for UEs 705-a and 705-b. For example, the assistance information may include existing sidelink DRX (e.g., C-DRX, I-DRX) configurations established or configured at the receiving UE 705-a with other transmitting UEs.

At 720, the DU 710-a may transmit the assistance information to the DU 710-b (e.g., the DU that is connected to the transmitting UE 705-b). The assistance information may include information transmitted to DU 710-a at 715 by receiving UE 705-a, such as existing sidelink C-DRX configurations of receiving UE 705-a with other transmitting UEs. Since the Uu DRX configuration of receiving UE 705-a is known to base station 710-a, it may also include the Uu DRX configuration with the assistance information received from the receiving UE 705-a by appending the Uu DRX configuration with the assistance information.

At 725, the DU 710-b may determine DRX configurations for receiving UE 705-a and transmitting UE 705-b. For example, the DU 710-b may determine the DRX configurations based on the assistance information received from DU 710-a. The determined configurations may include a sidelink DRX configuration (e.g., SL C-DRX) for the receiving UE 705-a to use in communications with transmitting UE 705-b. The DU 710-b may also select a sidelink configuration (e.g., SL C-DRX) that is aligned with the Uu DRX configuration of receiving UE 705-a. In addition, the DU 710-b may determine one or more configurations (such as a Uu DRX configuration) for the transmitting UE 705-b to use in communications with DU 710-b. In such cases, the configurations for the transmitting UE 705-b may be aligned with the configurations determined for the receiving UE 705-a.

In some other examples, the DUs 710-a and 710-b may receive one or more pre-configurations from a CU, which each DU may use to determine one or more DRX configurations for communications between the UEs 705-a and 705-b. The pre-configurations may include a number of parameters or additional information that the DUs 710-a and 710-b may use to determine one or more sidelink or Uu DRX configurations, and coordinate the configurations with one another.

At 730, the DU 710-b may transmit the determined SL DRX configuration and the Uu DRX configuration for the receiving UE 705-a to the DU 710-a. In some examples, the sidelink DRX configuration and the Uu DRX configuration may be based on the one or more pre-configurations received from the CU.

At 735-a, the DU 710-a may transmit the SL DRX configuration and the Uu DRX configuration to the receiving UE 705-a, and at 735-b, the DU 710-b may transmit the Uu DRX configuration to transmitting UE 705-b. As described in FIG. 7, the direct communication between DUs 710-a and 710-b may reduce excess signaling and resource usage between UEs 705-a and 705-b communicating via sidelink DRX.

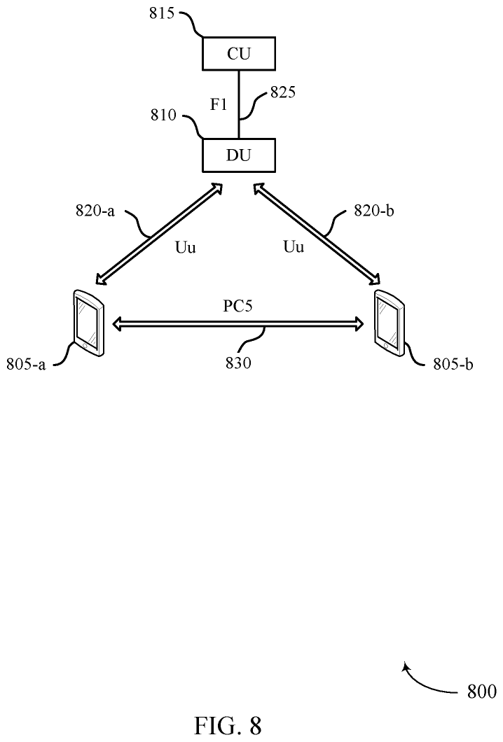

FIG. 8 illustrates an example of a wireless communications system 800 that supports coordination during access link DRX and sidelink alignment in accordance with aspects of the present disclosure. For example, the wireless communication system 800 may include an example configuration in which transmitting and a receiving user devices such as UE are associated with a same DU and a same CU. In some examples, the DU and CU may form part of a single base station (e.g., gNB) or different base stations. The base station (including the CU 815 and the DU 810) and UEs 805-a and 8-5-b may be examples of corresponding devices described with reference to FIGS. 1 and 2.

Based on sharing the CU 815 and the DU 815, the UEs 805-a and 805-b may also share common control layers from their respective serving cells with a common decision making place for determining layer-1, layer-2, or layer 3 signaling. The DU 810 may be associated with or connected to a transmitting UE 805-a and a receiving UE and the UE 805-a and the DU 810 may exchange information with the UE 805-a through the Uu interface 820-a, and may exchange information with the UE 805-b through the Uu interface 820-b.

In wireless communications system 800, the CU 815 and DU 810 may communicate via an F1 interface 825, which may be an example on an Xn interface or a direct link between base stations or base station components as described herein. In some cases, the Xn interface 825 may allow the CU 815 to directly exchange information with the DU 810 without involving communications between user devices on the sidelink or PC5 link 830. For example, the direct communication between the CU 815 and the DU 810 may allow the wireless communication system 800 to avoid using sidelink signaling 830 for exchanging sidelink or Uu link configuration information.

In some examples, the DU 810 and the CU 815 may transmit additional signaling via the Xn interface 825 to further facilitate communications between devices or device components. For example, this additional signaling may include assistance information from one or more of the UEs 805-a and 805-b, the Uu DRX configuration of the receiving UE 805-b, the sidelink DRX configuration of receiving UE 805-b with transmitting UE 805-a, and other existing SL DRX configurations of receiving UE 805-b with other transmitting UEs.

In some cases, based on the assistance information received from the DU 810, the CU 815 may determine the Uu DRX configuration of the receiving UE 805-b, the sidelink DRX configuration of receiving UE 805-b with transmitting UE 805-a, and the Uu DRX configuration for the transmitting UE 805-a. The CU 815 may transmit this information to the DU 810, and the DU 810 may transmit the respective configurations to the UEs 805-a and 805-b. In some other examples, the CU 815 may transmit one or more pre-configurations to the DU 810, and the DU 810 may determine respective DRX configurations for UEs 805-a and 805-b using the one or more pre-configurations received from the CU 815. In some cases, if the pre-configurations are unsuccessful, the DU 810 may request configurations from the CU 815.

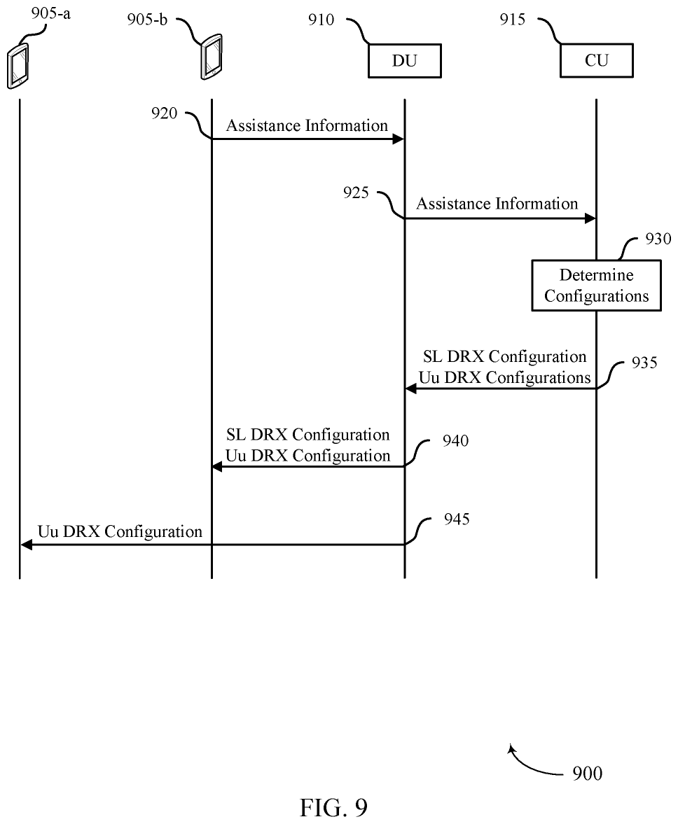

FIG. 9 illustrates an example of a process flow 900 that supports coordination during access link DRX and sidelink alignment in accordance with aspects of the present disclosure. The process flow 900 may implement aspects of wireless communications systems 100, 200, and 800, or may be implemented by aspects of the wireless communications systems 100, 200, and 500. For example, the process flow 900 may illustrate operations between a UE 905-a, a UE 905-b, a CU 915, and a DU 910, which may be examples of corresponding devices described with reference to FIGS. 1, 2, and 8. In the following description of the process flow 900, the operations between the devices may be transmitted in a different order than the example order shown, or the operations may be performed in different orders or at different times or by different devices. Additionally or alternatively, some operations may also be omitted from the process flow 900, and other operations may be added to the process flow 900.

In some examples, process flow 900 may illustrate communications in which UEs 905-a and 905-b are both connected to the DU 910 and the CU 915. At 920, the receiving UE 905-b may transmit assistance information to the DU 910 (e.g., the DU that is associated with or otherwise connected to the receiving UE 905-b). The assistance information may include information that is unknown to the DU 910 that the DU 910 or the CU 915 may use for determining one or more DRX configurations for UEs 905-a and 905-b. For example, the assistance information may include existing sidelink DRX (e.g., C-DRX, I-DRX) configurations established or configured at the receiving UE 905-b with other transmitting UEs.

At 925, the DU 910 may transmit the assistance information to the CU 915 (e.g., the CU which is connected with both the DU 910) via a direct connection with the CU 915. The assistance information may include information transmitted to DU 910 at 920 by receiving UE 905-b, such as existing sidelink C-DRX configurations of receiving UE 905-a with other transmitting UEs.

At 930, the CU 915 may determine DRX configurations for receiving UE 905-a and transmitting UE 905-b. For example, the CU 915 may determine the DRX configurations based on the assistance information received from DU 910. The determined configurations may include a sidelink DRX configuration (e.g., SL C-DRX) for the receiving UE 905-b to use in communications with transmitting UE 905-a. In addition, the CU 915 may determine one or more configurations (such as a Uu DRX configuration) for the transmitting UE 905-a to use in communications with DU 910. In such cases, the configurations for the transmitting UE 905-a may be aligned with the configurations determined for the receiving UE 905-b. For example, the configurations may support coordinated communications between the UE 910-a and 905-b, such that the configurations support signaling that does not overlap or otherwise interfere.

At 935, the CU 915 may transmit the determined SL DRX configuration and the Uu DRX configuration for the receiving UE 905-b to the DU, and at 940, the DU 910 may transmit the SL DRX configuration and the Uu DRX configuration determined by the CU 915 to the receiving UE 905-b.

At 945, the DU 910 may transmit the Uu DRX configuration determined by the CU 915 to transmitting UE 905-a. As described in FIG. 9, the direct communication between DU 910 and CU 915 may reduce excess signaling and resource usage between UEs 905-a and 905-b communicating via sidelink DRX. In addition, the CU 915 may determine the DRX configurations for both the UEs 905-a and 905-b, which may reduce excess sidelink resource consumption for the UEs 905-a and 905-b, while increasing coordination between devices.

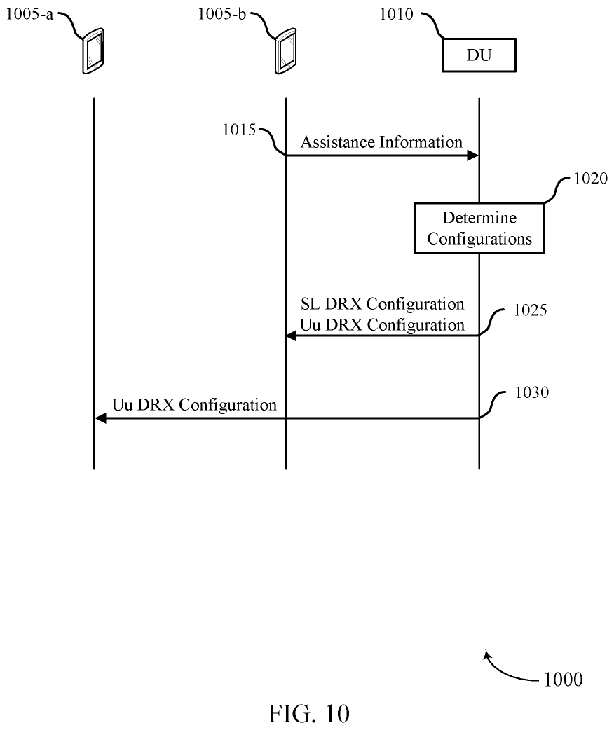

FIG. 10 illustrates an example of a process flow 1000 that supports coordination during access link DRX and sidelink alignment in accordance with aspects of the present disclosure. The process flow 1000 may implement aspects of wireless communications systems 100 and 200, or may be implemented by aspects of the wireless communications systems 100 and 200. For example, the process flow 1000 may illustrate operations between a UE 1005-a, a UE 1005-b, and a DU 1010, which may be examples of corresponding devices described with reference to FIGS. 1 and 2. In the following description of the process flow 1000, the operations between the devices may be transmitted in a different order than the example order shown, or the operations may be performed in different orders or at different times or by different devices. Additionally or alternatively, some operations may also be omitted from the process flow 1000, and other operations may be added to the process flow 1000. In some examples, process flow 1000 may illustrate communications in which UEs 1005-a and 1005-b are both connected to the DU 1010.

At 1015, the receiving UE 1005-b may transmit assistance information to the DU 1010. The assistance information may include information that is unknown to the DU 1010 that the DU 1010 may use for determining one or more DRX configurations for UEs 1005-a and 1005-b. For example, the assistance information may include existing sidelink DRX (e.g., C-DRX, I-DRX) configurations established or configured at the receiving UE 1005-b with other transmitting UEs.

At 1020, the DU 1010 may determine DRX configurations for receiving UE 1005-a and transmitting UE 1005-b. For example, the DU 1010 may determine the DRX configurations based on the assistance information received from receiving UE 1005-b. The determined configurations may include a sidelink DRX configuration (e.g., SL C-DRX) for the receiving UE 1005-b to use in communications with transmitting UE 1005-a. In addition, the DU 1010 may determine one or more configurations (such as a Uu DRX configuration) for the transmitting UE 1005-a to use in communications with DU 1010. In such cases, the configurations for the transmitting UE 1005-a may be aligned with the configurations determined for the receiving UE 1005-b. For example, the configurations may support coordinated communications between the UE 1010-a and 1005-b, such that the configurations support signaling that does not overlap or otherwise interfere.

At 1025, the DU 1010 may transmit the determined SL DRX configuration and the Uu DRX configuration to the receiving UE 1005-b, and at 1030, the DU 1010 may transmit the determined Uu DRX configuration to the transmitting UE 1005.

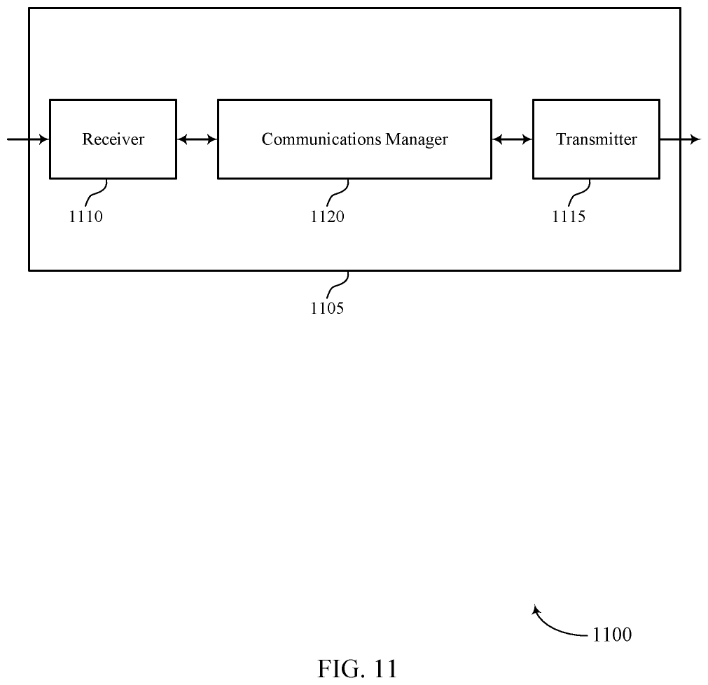

FIG. 11 shows a block diagram 1100 of a device 1105 that supports coordination during access link DRX and sidelink alignment in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to coordination during access link DRX and sidelink alignment). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to coordination during access link DRX and sidelink alignment). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of coordination during access link DRX and sidelink alignment as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a first base station in accordance with examples as disclosed herein. For example, the communications manager 1120 may be configured as or otherwise support a means for receiving, from a first UE, an assistance information message associated with a sidelink DRX configuration for communications between the first UE and a second UE. The communications manager 1120 may be configured as or otherwise support a means for transmitting, to a second base station, the assistance information message received from the first UE. The communications manager 1120 may be configured as or otherwise support a means for communicating, with the second base station via an interface between the first base station and the second base station, an indication of the sidelink DRX configuration for the first UE. The communications manager 1120 may be configured as or otherwise support a means for transmitting, to the first UE, an indication of the sidelink DRX configuration and an indication of an access link DRX configuration for the first UE based on the communicating.

Additionally or alternatively, the communications manager 1120 may support wireless communication at a second base station in accordance with examples as disclosed herein. For example, the communications manager 1120 may be configured as or otherwise support a means for receiving, from a first base station, an assistance information message from a first UE, the assistance information message for determining a sidelink DRX configuration for communications between the first UE and a second UE. The communications manager 1120 may be configured as or otherwise support a means for transmitting, to the first base station, an indication of the sidelink DRX configuration determined for the first UE via an interface between the first base station and the second base station. The communications manager 1120 may be configured as or otherwise support a means for transmitting, to the second UE, an indication of an access link DRX configuration for communications between the second UE and the second base station.

Additionally or alternatively, the communications manager 1120 may support wireless communication in accordance with examples as disclosed herein. For example, the communications manager 1120 may be configured as or otherwise support a means for receiving, from a first UE, a first assistance information message at a first DU, the first assistance information message associated with a sidelink DRX configuration for communications between the first UE and a second UE. The communications manager 1120 may be configured as or otherwise support a means for receiving, at a CU, the first assistance information message relayed by the first DU to the CU. The communications manager 1120 may be configured as or otherwise support a means for communicating, between the CU and at least the first DU, an indication of the sidelink DRX configuration for the first UE and an indication of a first access link DRX configuration for the first UE. The communications manager 1120 may be configured as or otherwise support a means for transmitting, to the first UE, the indication of the sidelink DRX configuration and the indication of the first access link DRX configuration based on the communicating.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced processing, reduced power consumption, and more efficient utilization of communication resources.

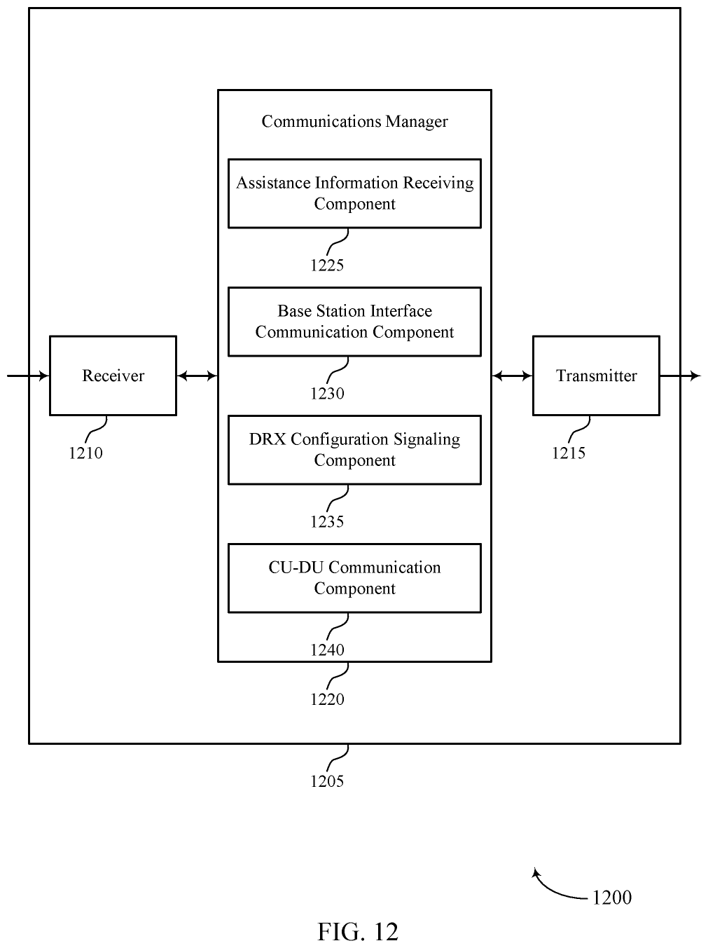

FIG. 12 shows a block diagram 1200 of a device 1205 that supports coordination during access link DRX and sidelink alignment in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to coordination during access link DRX and sidelink alignment). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to coordination during access link DRX and sidelink alignment). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of coordination during access link DRX and sidelink alignment as described herein. For example, the communications manager 1220 may include an assistance information receiving component 1225, a base station interface communication component 1230, a DRX configuration signaling component 1235, a CU-DU communication component 1240, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a first base station in accordance with examples as disclosed herein. The assistance information receiving component 1225 may be configured as or otherwise support a means for receiving, from a first UE, an assistance information message associated with a sidelink DRX configuration for communications between the first UE and a second UE. The base station interface communication component 1230 may be configured as or otherwise support a means for transmitting, to a second base station, the assistance information message received from the first UE. The base station interface communication component 1230 may be configured as or otherwise support a means for communicating, with the second base station via an interface between the first base station and the second base station, an indication of the sidelink DRX configuration for the first UE. The DRX configuration signaling component 1235 may be configured as or otherwise support a means for transmitting, to the first UE, an indication of the sidelink DRX configuration and an indication of an access link DRX configuration for the first UE based on the communicating.

Additionally or alternatively, the communications manager 1220 may support wireless communication at a second base station in accordance with examples as disclosed herein. The assistance information receiving component 1225 may be configured as or otherwise support a means for receiving, from a first base station, an assistance information message from a first UE, the assistance information message for determining a sidelink DRX configuration for communications between the first UE and a second UE. The base station interface communication component 1230 may be configured as or otherwise support a means for transmitting, to the first base station, an indication of the sidelink DRX configuration determined for the first UE via an interface between the first base station and the second base station. The DRX configuration signaling component 1235 may be configured as or otherwise support a means for transmitting, to the second UE, an indication of an access link DRX configuration for communications between the second UE and the second base station.

Additionally or alternatively, the communications manager 1220 may support wireless communication in accordance with examples as disclosed herein. The assistance information receiving component 1225 may be configured as or otherwise support a means for receiving, from a first UE, a first assistance information message at a first DU, the first assistance information message associated with a sidelink DRX configuration for communications between the first UE and a second UE. The CU-DU communication component 1240 may be configured as or otherwise support a means for receiving, at a CU, the first assistance information message relayed by the first DU to the CU. The CU-DU communication component 1240 may be configured as or otherwise support a means for communicating, between the CU and at least the first DU, an indication of the sidelink DRX configuration for the first UE and an indication of a first access link DRX configuration for the first UE. The DRX configuration signaling component 1235 may be configured as or otherwise support a means for transmitting, to the first UE, the indication of the sidelink DRX configuration and the indication of the first access link DRX configuration based on the communicating.

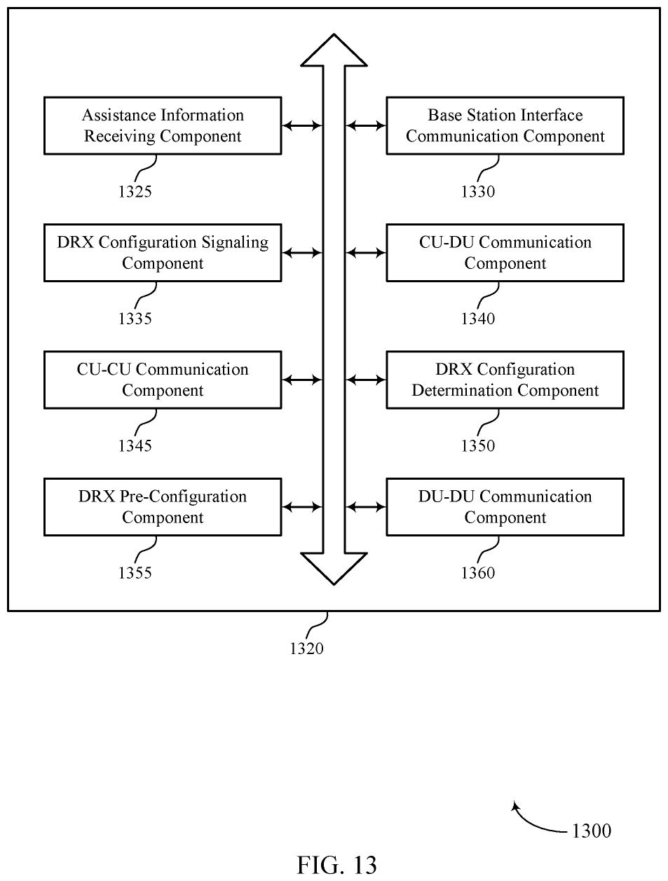

FIG. 13 shows a block diagram 1300 of a communications manager 1320 that supports coordination during access link DRX and sidelink alignment in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of coordination during access link DRX and sidelink alignment as described herein. For example, the communications manager 1320 may include an assistance information receiving component 1325, a base station interface communication component 1330, a DRX configuration signaling component 1335, a CU-DU communication component 1340, a CU-CU communication component 1345, a DRX configuration determination component 1350, a DRX pre-configuration component 1355, a DU-DU communication component 1360, or any combination thereof. Each of these components may communicate, directly or indirectly, with one another (e.g., via one or more buses).

The communications manager 1320 may support wireless communication at a first base station in accordance with examples as disclosed herein. The assistance information receiving component 1325 may be configured as or otherwise support a means for receiving, from a first UE, an assistance information message associated with a sidelink DRX configuration for communications between the first UE and a second UE. The base station interface communication component 1330 may be configured as or otherwise support a means for transmitting, to a second base station, the assistance information message received from the first UE. In some examples, the base station interface communication component 1330 may be configured as or otherwise support a means for communicating, with the second base station via an interface between the first base station and the second base station, an indication of the sidelink DRX configuration for the first UE. The DRX configuration signaling component 1335 may be configured as or otherwise support a means for transmitting, to the first UE, an indication of the sidelink DRX configuration and an indication of an access link DRX configuration for the first UE based on the communicating.

In some examples, to support communicating with the second base station via the interface, the CU-CU communication component 1345 may be configured as or otherwise support a means for transmitting the assistance information message between the first base station and the second base station via a connection between a first CU of the first base station and a second CU of the second base station.

In some examples, the CU-DU communication component 1340 may be configured as or otherwise support a means for relaying the indication of the sidelink DRX configuration and the indication of the access link DRX configuration from a first CU of the first base station to a first DU of the first base station. In some examples, the DRX configuration signaling component 1335 may be configured as or otherwise support a means for transmitting, to the first UE, the indication of the sidelink DRX configuration and the indication of the access link DRX configuration via an access link between the first UE and the first DU.

In some examples, the base station interface communication component 1330 may be configured as or otherwise support a means for transmitting the assistance information message to the second base station, the assistance information message including a field including one or more additional sidelink DRX configurations associated with one or more additional sidelink UEs, and a field including the indication of the access link DRX configuration for the first UE.

In some examples, the sidelink DRX configuration for the first UE includes one or more sidelink DRX alignment parameters.

In some examples, the access link DRX configuration for the second UE includes one or more access link DRX alignment parameters.

Additionally or alternatively, the communications manager 1320 may support wireless communication at a second base station in accordance with examples as disclosed herein. In some examples, the assistance information receiving component 1325 may be configured as or otherwise support a means for receiving, from a first base station, an assistance information message from a first UE, the assistance information message for determining a sidelink DRX configuration for communications between the first UE and a second UE. In some examples, the base station interface communication component 1330 may be configured as or otherwise support a means for transmitting, to the first base station, an indication of the sidelink DRX configuration determined for the first UE via an interface between the first base station and the second base station. In some examples, the DRX configuration signaling component 1335 may be configured as or otherwise support a means for transmitting, to the second UE, an indication of an access link DRX configuration for communications between the second UE and the second base station.

In some examples, to support communicating with the first base station via the interface, the CU-CU communication component 1345 may be configured as or otherwise support a means for receiving the assistance information message from the first base station via a connection between a first CU of the first base station and a second CU of the second base station.

In some examples, the DRX configuration determination component 1350 may be configured as or otherwise support a means for determining the sidelink DRX configuration for the first UE and the access link DRX configuration for the second UE. In some examples, the base station interface communication component 1330 may be configured as or otherwise support a means for transmitting, to the first base station, the indication of the sidelink DRX configuration for the first UE via the interface between the second base station and the first base station. In some examples, the DRX configuration signaling component 1335 may be configured as or otherwise support a means for transmitting, to the second UE, the indication of the access link DRX configuration for the second UE based on the determining.

In some examples, the assistance information receiving component 1325 may be configured as or otherwise support a means for receiving the assistance information message from the first base station, the assistance information message including a field including one or more additional sidelink DRX configurations associated with one or more additional sidelink UEs, and a field including the indication of the access link DRX configuration for the first UE.

In some examples, the sidelink DRX configuration for the first UE includes one or more sidelink DRX alignment parameters.

In some examples, the access link DRX configuration for the second UE includes one or more access link DRX alignment parameters.

Additionally or alternatively, the communications manager 1320 may support wireless communication in accordance with examples as disclosed herein. In some examples, the assistance information receiving component 1325 may be configured as or otherwise support a means for receiving, from a first UE, a first assistance information message at a first DU, the first assistance information message associated with a sidelink DRX configuration for communications between the first UE and a second UE. The CU-DU communication component 1340 may be configured as or otherwise support a means for receiving, at a CU, the first assistance information message relayed by the first DU to the CU. In some examples, the CU-DU communication component 1340 may be configured as or otherwise support a means for communicating, between the CU and at least the first DU, an indication of the sidelink DRX configuration for the first UE and an indication of a first access link DRX configuration for the first UE. In some examples, the DRX configuration signaling component 1335 may be configured as or otherwise support a means for transmitting, to the first UE, the indication of the sidelink DRX configuration and the indication of the first access link DRX configuration based on the communicating.

In some examples, the assistance information receiving component 1325 may be configured as or otherwise support a means for receiving, from the second UE, a second assistance information message at a second DU. In some examples, the assistance information receiving component 1325 may be configured as or otherwise support a means for receiving, at the CU, the second assistance information message relayed by the second DU to the CU. In some examples, the CU-DU communication component 1340 may be configured as or otherwise support a means for communicating, between the CU and the second DU, an indication of a second access link DRX configuration for the second UE. In some examples, the DRX configuration signaling component 1335 may be configured as or otherwise support a means for transmitting, to the second UE, the indication of the first access link DRX configuration based on the communicating.

In some examples, the DRX pre-configuration component 1355 may be configured as or otherwise support a means for receiving, at the first DU and a second DU, one or more pre-configurations for determining one or more DRX configurations for the first UE and the second UE. In some examples, the DRX configuration signaling component 1335 may be configured as or otherwise support a means for transmitting, to the first UE via the first DU, the indication of the sidelink DRX configuration and the indication of the first access link DRX configuration based on the one or more pre-configurations. In some examples, the DRX configuration signaling component 1335 may be configured as or otherwise support a means for transmitting, to the second UE via the second DU, an indication of a second access link DRX configuration based on the one or more pre-configurations.

In some examples, the DU-DU communication component 1360 may be configured as or otherwise support a means for communicating, between the first DU and the second DU, the one or more DRX configurations for the first UE and the second UE based on the one or more pre-configurations.

In some examples, the DU-DU communication component 1360 may be configured as or otherwise support a means for communicating, between the first DU and a second DU, the first assistance information message, the indication of the sidelink DRX configuration, the indication of the first access link DRX configuration, or any combination thereof.

In some examples, the CU determines the sidelink DRX configuration for the first UE, the first access link DRX configuration for the first UE, and the second access link DRX configuration for the second UE.

In some examples, the assistance information receiving component 1325 may be configured as or otherwise support a means for receiving, from the second UE, a second assistance information message at the first DU. In some examples, the CU-DU communication component 1340 may be configured as or otherwise support a means for receiving, at the CU, the second assistance information message relayed by the first DU to the CU. In some examples, the CU-DU communication component 1340 may be configured as or otherwise support a means for communicating, between the CU and the first DU, an indication of a second access link DRX configuration for the second UE. In some examples, the DRX configuration signaling component 1335 may be configured as or otherwise support a means for transmitting, to the second UE, the indication of the first access link DRX configuration based on the communicating.

In some examples, the DRX pre-configuration component 1355 may be configured as or otherwise support a means for receiving, at the first DU, one or more pre-configurations for determining one or more DRX configurations for the first UE and the second UE. In some examples, the DRX configuration signaling component 1335 may be configured as or otherwise support a means for transmitting, to the first UE via the first DU, the indication of the sidelink DRX configuration and the indication of the first access link DRX configuration based on the one or more pre-configurations. In some examples, the DRX configuration signaling component 1335 may be configured as or otherwise support a means for transmitting, to the second UE via the first DU, an indication of a second access link DRX configuration based on the one or more pre-configurations.

In some examples, the CU-DU communication component 1340 may be configured as or otherwise support a means for communicating, between the CU and the first DU, the one or more DRX configurations for the first UE and the second UE based on the one or more pre-configurations.

In some examples, the CU-DU communication component 1340 may be configured as or otherwise support a means for communicating, between the CU and the first DU and a second DU, the first assistance information message, the indication of the sidelink DRX configuration, the indication of the first access link DRX configuration, or any combination thereof.

In some examples, the first assistance information message includes one or more additional indications of sidelink connected mode DRX configurations established between the first UE and one or more other sidelink UEs.

In some examples, the DRX configuration signaling component 1335 may be configured as or otherwise support a means for communicating via layer-1 signaling, layer-2 signaling, layer-3 signaling, or any combination thereof.

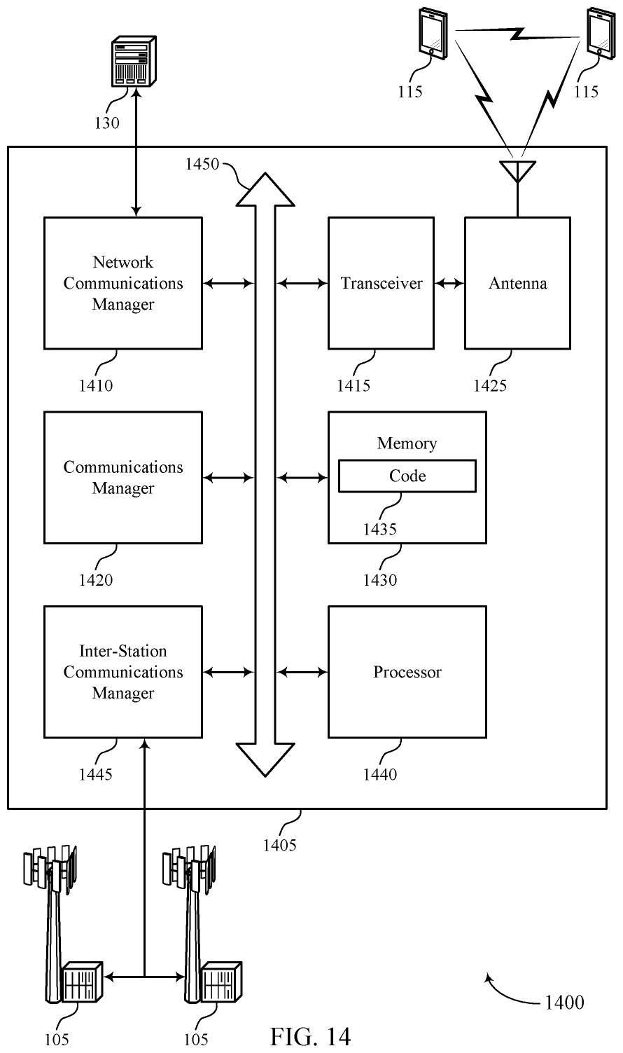

FIG. 14 shows a diagram of a system 1400 including a device 1405 that supports coordination during access link DRX and sidelink alignment in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting coordination during access link DRX and sidelink alignment). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a first base station in accordance with examples as disclosed herein. For example, the communications manager 1420 may be configured as or otherwise support a means for receiving, from a first UE, an assistance information message associated with a sidelink DRX configuration for communications between the first UE and a second UE. The communications manager 1420 may be configured as or otherwise support a means for transmitting, to a second base station, the assistance information message received from the first UE. The communications manager 1420 may be configured as or otherwise support a means for communicating, with the second base station via an interface between the first base station and the second base station, an indication of the sidelink DRX configuration for the first UE. The communications manager 1420 may be configured as or otherwise support a means for transmitting, to the first UE, an indication of the sidelink DRX configuration and an indication of an access link DRX configuration for the first UE based on the communicating.

Additionally or alternatively, the communications manager 1420 may support wireless communication at a second base station in accordance with examples as disclosed herein. For example, the communications manager 1420 may be configured as or otherwise support a means for receiving, from a first base station, an assistance information message from a first UE, the assistance information message for determining a sidelink DRX configuration for communications between the first UE and a second UE. The communications manager 1420 may be configured as or otherwise support a means for transmitting, to the first base station, an indication of the sidelink DRX configuration determined for the first UE via an interface between the first base station and the second base station. The communications manager 1420 may be configured as or otherwise support a means for transmitting, to the second UE, an indication of an access link DRX configuration for communications between the second UE and the second base station.

Additionally or alternatively, the communications manager 1420 may support wireless communication in accordance with examples as disclosed herein. For example, the communications manager 1420 may be configured as or otherwise support a means for receiving, from a first UE, a first assistance information message at a first DU, the first assistance information message associated with a sidelink DRX configuration for communications between the first UE and a second UE. The communications manager 1420 may be configured as or otherwise support a means for receiving, at a CU, the first assistance information message relayed by the first DU to the CU. The communications manager 1420 may be configured as or otherwise support a means for communicating, between the CU and at least the first DU, an indication of the sidelink DRX configuration for the first UE and an indication of a first access link DRX configuration for the first UE. The communications manager 1420 may be configured as or otherwise support a means for transmitting, to the first UE, the indication of the sidelink DRX configuration and the indication of the first access link DRX configuration based on the communicating.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, improved utilization of processing capability, increased throughput, and increased utilization of available sidelink resources.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of coordination during access link DRX and sidelink alignment as described herein, or the processor 1440 and the memory 1430 may be otherwise configured to perform or support such operations.

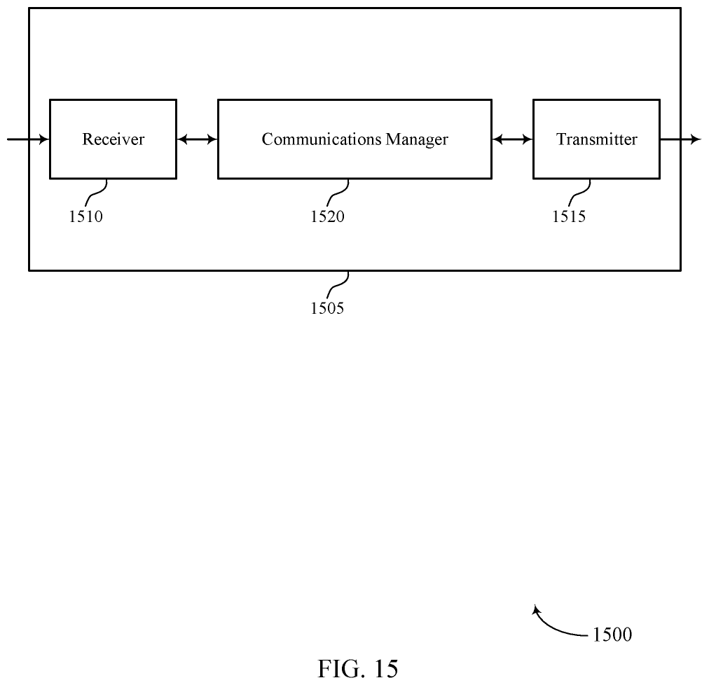

FIG. 15 shows a block diagram 1500 of a device 1505 that supports coordination during access link DRX and sidelink alignment in accordance with aspects of the present disclosure. The device 1505 may be an example of aspects of a UE 115 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to coordination during access link DRX and sidelink alignment). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to coordination during access link DRX and sidelink alignment). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of coordination during access link DRX and sidelink alignment as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a first UE in accordance with examples as disclosed herein. For example, the communications manager 1520 may be configured as or otherwise support a means for transmitting, to a base station, an assistance information message associated with a sidelink DRX configuration for communications between the first UE and a second UE. The communications manager 1520 may be configured as or otherwise support a means for receiving, from the base station, an indication of the sidelink DRX configuration and an indication of an access link DRX configuration. The communications manager 1520 may be configured as or otherwise support a means for communicating with the second UE via a sidelink in accordance with the received sidelink DRX configuration. The communications manager 1520 may be configured as or otherwise support a means for communicating with the base station via an access link in accordance with the received access link DRX configuration.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for reduced processing, reduced power consumption, and more efficient utilization of communication resources.

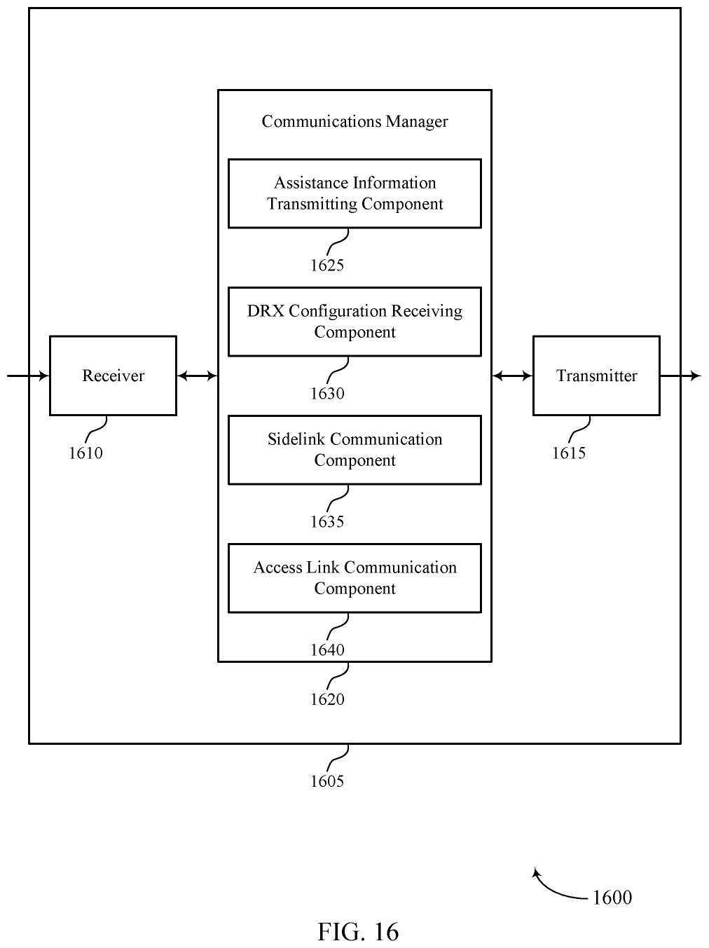

FIG. 16 shows a block diagram 1600 of a device 1605 that supports coordination during access link DRX and sidelink alignment in accordance with aspects of the present disclosure. The device 1605 may be an example of aspects of a device 1505 or a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to coordination during access link DRX and sidelink alignment). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to coordination during access link DRX and sidelink alignment). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of coordination during access link DRX and sidelink alignment as described herein. For example, the communications manager 1620 may include an assistance information transmitting component 1625, a DRX configuration receiving component 1630, a sidelink communication component 1635, an access link communication component 1640, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication at a first UE in accordance with examples as disclosed herein. The assistance information transmitting component 1625 may be configured as or otherwise support a means for transmitting, to a base station, an assistance information message associated with a sidelink DRX configuration for communications between the first UE and a second UE. The DRX configuration receiving component 1630 may be configured as or otherwise support a means for receiving, from the base station, an indication of the sidelink DRX configuration and an indication of an access link DRX configuration. The sidelink communication component 1635 may be configured as or otherwise support a means for communicating with the second UE via a sidelink in accordance with the received sidelink DRX configuration. The access link communication component 1640 may be configured as or otherwise support a means for communicating with the base station via an access link in accordance with the received access link DRX configuration.

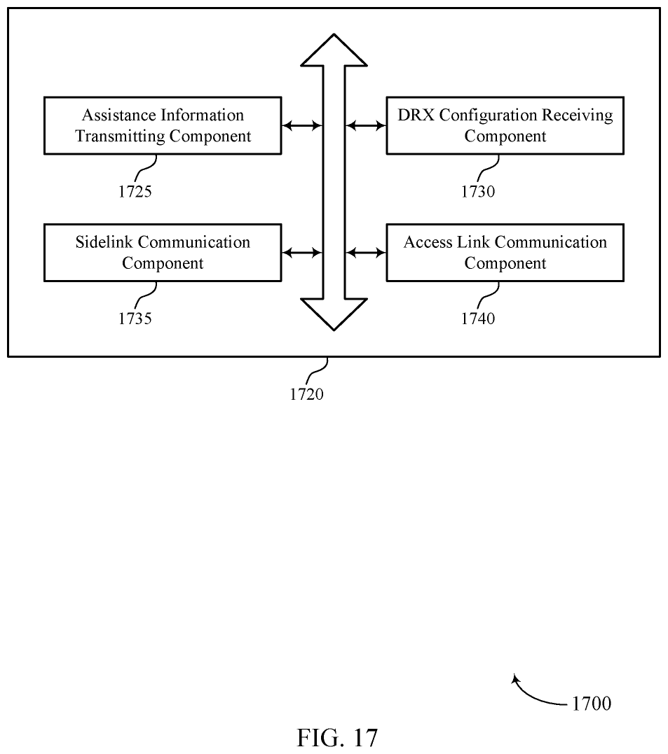

FIG. 17 shows a block diagram 1700 of a communications manager 1720 that supports coordination during access link DRX and sidelink alignment in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of coordination during access link DRX and sidelink alignment as described herein. For example, the communications manager 1720 may include an assistance information transmitting component 1725, a DRX configuration receiving component 1730, a sidelink communication component 1735, an access link communication component 1740, or any combination thereof. Each of these components may communicate, directly or indirectly, with one another (e.g., via one or more buses).

The communications manager 1720 may support wireless communication at a first UE in accordance with examples as disclosed herein. The assistance information transmitting component 1725 may be configured as or otherwise support a means for transmitting, to a base station, an assistance information message associated with a sidelink DRX configuration for communications between the first UE and a second UE. The DRX configuration receiving component 1730 may be configured as or otherwise support a means for receiving, from the base station, an indication of the sidelink DRX configuration and an indication of an access link DRX configuration. The sidelink communication component 1735 may be configured as or otherwise support a means for communicating with the second UE via a sidelink in accordance with the received sidelink DRX configuration. The access link communication component 1740 may be configured as or otherwise support a means for communicating with the base station via an access link in accordance with the received access link DRX configuration.

In some examples, the DRX configuration receiving component 1730 may be configured as or otherwise support a means for receiving, via a first DU of the base station, the indication of the sidelink DRX configuration and the indication of the access link DRX configuration based on one or more pre-configurations.

In some examples, to support transmitting the assistance information message, the assistance information transmitting component 1725 may be configured as or otherwise support a means for transmitting the assistance information message via the access link to a first DU of the base station.

In some examples, the assistance information message includes one or more additional indications of sidelink connected mode DRX configurations established between the first UE and one or more other sidelink UEs.

In some examples, the DRX configuration receiving component 1730 may be configured as or otherwise support a means for communicating via layer-1 signaling, layer-2 signaling, layer-3 signaling, or any combination thereof.

In some examples, the sidelink communication component 1735 may be configured as or otherwise support a means for refraining from transmitting the sidelink DRX configuration to the second UE based on receiving the indication of the sidelink DRX configuration from the base station.

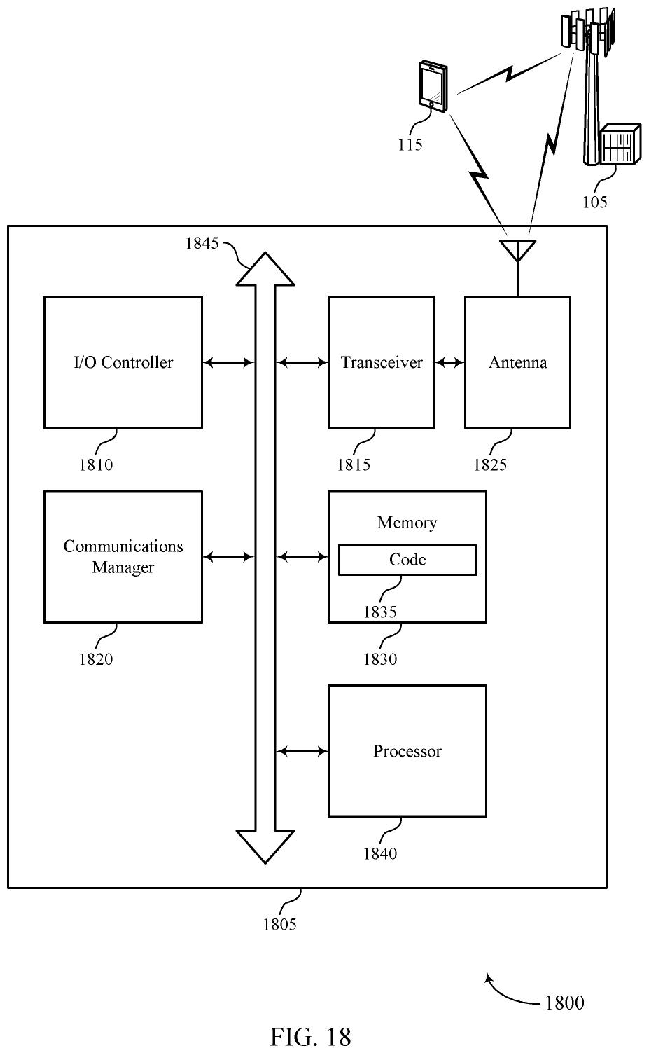

FIG. 18 shows a diagram of a system 1800 including a device 1805 that supports coordination during access link DRX and sidelink alignment in accordance with aspects of the present disclosure. The device 1805 may be an example of or include the components of a device 1505, a device 1605, or a UE 115 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, an input/output (I/O) controller 1810, a transceiver 1815, an antenna 1825, a memory 1830, code 1835, and a processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally or alternatively, the I/O controller 1810 may represent or interact with a modem, a keyboard, a mouse, a touchscreen, or a similar device. In some cases, the I/O controller 1810 may be implemented as part of a processor, such as the processor 1840. In some cases, a user may interact with the device 1805 via the I/O controller 1810 or via hardware components controlled by the I/O controller 1810.

In some cases, the device 1805 may include a single antenna 1825. However, in some other cases, the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include random access memory (RAM) and read-only memory (ROM). The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a basic I/O system (BIOS) which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting coordination during access link DRX and sidelink alignment). For example, the device 1805 or a component of the device 1805 may include a processor 1840 and memory 1830 coupled to the processor 1840, the processor 1840 and memory 1830 configured to perform various functions described herein.

The communications manager 1820 may support wireless communication at a first UE in accordance with examples as disclosed herein. For example, the communications manager 1820 may be configured as or otherwise support a means for transmitting, to a base station, an assistance information message associated with a sidelink DRX configuration for communications between the first UE and a second UE. The communications manager 1820 may be configured as or otherwise support a means for receiving, from the base station, an indication of the sidelink DRX configuration and an indication of an access link DRX configuration. The communications manager 1820 may be configured as or otherwise support a means for communicating with the second UE via a sidelink in accordance with the received sidelink DRX configuration. The communications manager 1820 may be configured as or otherwise support a means for communicating with the base station via an access link in accordance with the received access link DRX configuration.

By including or configuring the communications manager 1820 in accordance with examples as described herein, the device 1805 may support techniques for improved communication reliability, reduced latency, improved user experience related to reduced processing, reduced power consumption, more efficient utilization of communication resources, improved coordination between devices, longer battery life, improved utilization of processing capability, increased throughput, and increased utilization of available sidelink resources.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of coordination during access link DRX and sidelink alignment as described herein, or the processor 1840 and the memory 1830 may be otherwise configured to perform or support such operations.

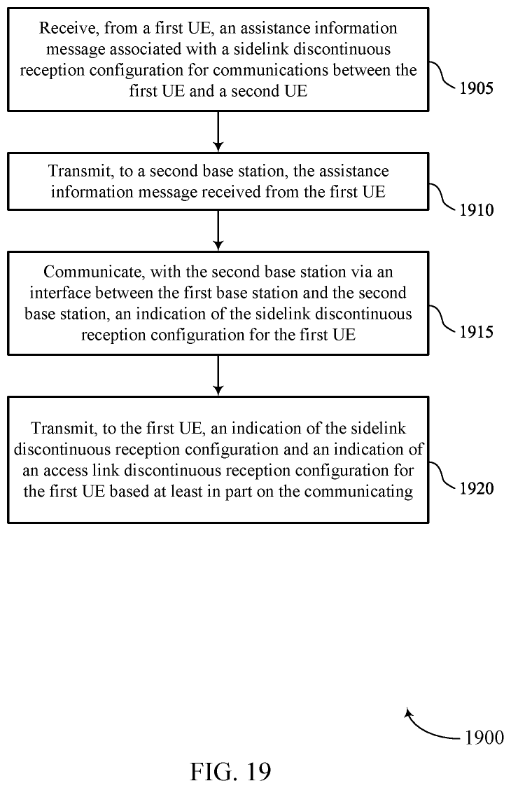

FIG. 19 shows a flowchart illustrating a method 1900 that supports coordination during access link DRX and sidelink alignment in accordance with aspects of the present disclosure. The operations of the method 1900 may be implemented by a base station or its components as described herein. For example, the operations of the method 1900 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 1905, the method may include receiving, from a first UE, an assistance information message associated with a sidelink DRX configuration for communications between the first UE and a second UE. The operations of 1905 may be performed in accordance with examples as disclosed herein. In some examples, aspects of the operations of 1905 may be performed by an assistance information receiving component 1325 as described with reference to FIG. 13.

At 1910, the method may include transmitting, to a second base station, the assistance information message received from the first UE. The operations of 1910 may be performed in accordance with examples as disclosed herein. In some examples, aspects of the operations of 1910 may be performed by a base station interface communication component 1330 as described with reference to FIG. 13.

At 1915, the method may include communicating, with the second base station via an interface between the first base station and the second base station, an indication of the sidelink DRX configuration for the first UE. The operations of 1915 may be performed in accordance with examples as disclosed herein. In some examples, aspects of the operations of 1915 may be performed by a base station interface communication component 1330 as described with reference to FIG. 13.

At 1920, the method may include transmitting, to the first UE, an indication of the sidelink DRX configuration and an indication of an access link DRX configuration for the first UE based on the communicating. The operations of 1920 may be performed in accordance with examples as disclosed herein. In some examples, aspects of the operations of 1920 may be performed by a DRX configuration signaling component 1335 as described with reference to FIG. 13.

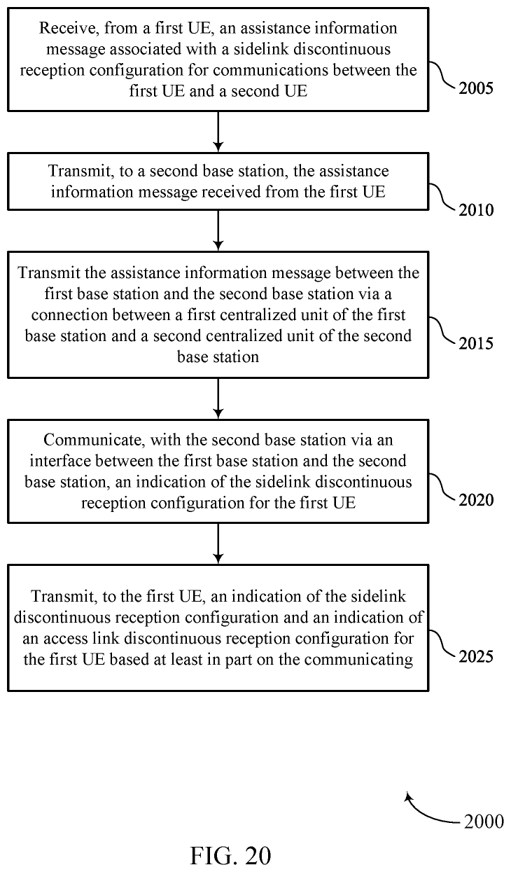

FIG. 20 shows a flowchart illustrating a method 2000 that supports coordination during access link DRX and sidelink alignment in accordance with aspects of the present disclosure. The operations of the method 2000 may be implemented by a base station or its components as described herein. For example, the operations of the method 2000 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 2005, the method may include receiving, from a first UE, an assistance information message associated with a sidelink DRX configuration for communications between the first UE and a second UE. The operations of 2005 may be performed in accordance with examples as disclosed herein. In some examples, aspects of the operations of 2005 may be performed by an assistance information receiving component 1325 as described with reference to FIG. 13.

At 2010, the method may include transmitting, to a second base station, the assistance information message received from the first UE. The operations of 2010 may be performed in accordance with examples as disclosed herein. In some examples, aspects of the operations of 2010 may be performed by a base station interface communication component 1330 as described with reference to FIG. 13.

At 2015, the method may include transmitting the assistance information message between the first base station and the second base station via a connection between a first CU of the first base station and a second CU of the second base station. The operations of 2015 may be performed in accordance with examples as disclosed herein. In some examples, aspects of the operations of 2015 may be performed by a CU-CU communication component 1345 as described with reference to FIG. 13.

At 2020, the method may include communicating, with the second base station via an interface between the first base station and the second base station, an indication of the sidelink DRX configuration for the first UE. The operations of 2020 may be performed in accordance with examples as disclosed herein. In some examples, aspects of the operations of 2020 may be performed by a base station interface communication component 1330 as described with reference to FIG. 13.

At 2025, the method may include transmitting, to the first UE, an indication of the sidelink DRX configuration and an indication of an access link DRX configuration for the first UE based on the communicating. The operations of 2025 may be performed in accordance with examples as disclosed herein. In some examples, aspects of the operations of 2025 may be performed by a DRX configuration signaling component 1335 as described with reference to FIG. 13.

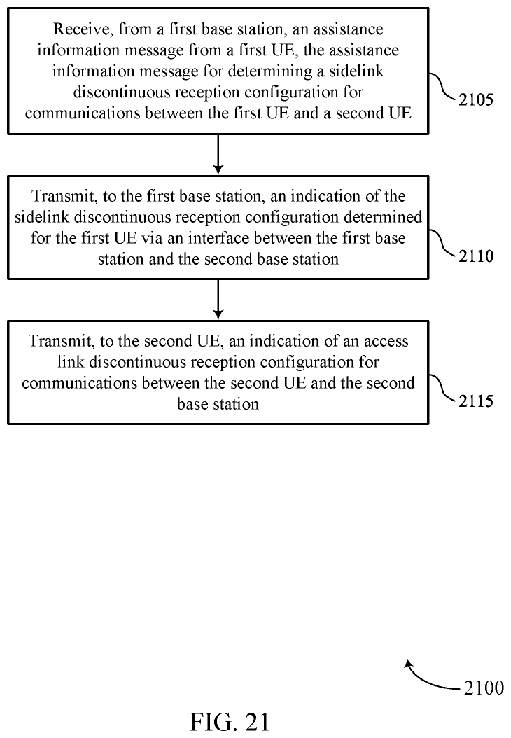

FIG. 21 shows a flowchart illustrating a method 2100 that supports coordination during access link DRX and sidelink alignment in accordance with aspects of the present disclosure. The operations of the method 2100 may be implemented by a base station or its components as described herein. For example, the operations of the method 2100 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 2105, the method may include receiving, from a first base station, an assistance information message from a first UE, the assistance information message for determining a sidelink DRX configuration for communications between the first UE and a second UE. The operations of 2105 may be performed in accordance with examples as disclosed herein. In some examples, aspects of the operations of 2105 may be performed by an assistance information receiving component 1325 as described with reference to FIG. 13.

At 2110, the method may include transmitting, to the first base station, an indication of the sidelink DRX configuration determined for the first UE via an interface between the first base station and the second base station. The operations of 2110 may be performed in accordance with examples as disclosed herein. In some examples, aspects of the operations of 2110 may be performed by a base station interface communication component 1330 as described with reference to FIG. 13.

At 2115, the method may include transmitting, to the second UE, an indication of an access link DRX configuration for communications between the second UE and the second base station. The operations of 2115 may be performed in accordance with examples as disclosed herein. In some examples, aspects of the operations of 2115 may be performed by a DRX configuration signaling component 1335 as described with reference to FIG. 13.

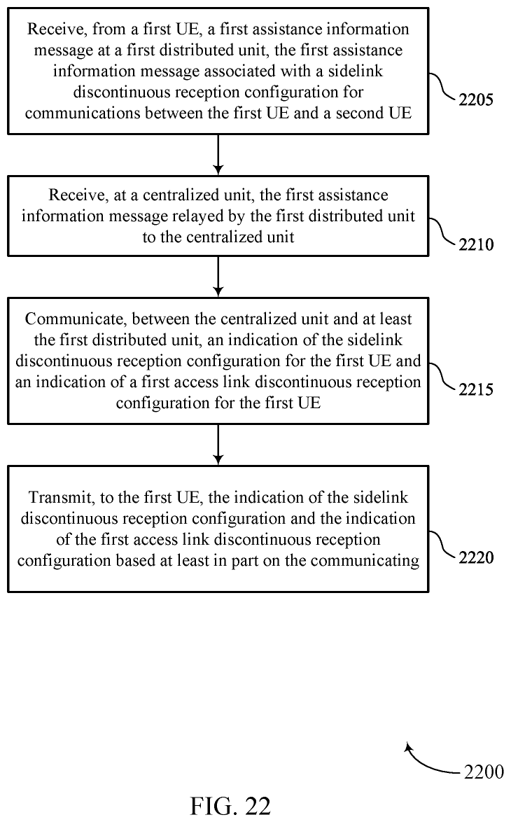

FIG. 22 shows a flowchart illustrating a method 2200 that supports coordination during access link DRX and sidelink alignment in accordance with aspects of the present disclosure. The operations of the method 2200 may be implemented by a base station or its components as described herein. For example, the operations of the method 2200 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 2205, the method may include receiving, from a first UE, a first assistance information message at a first DU, the first assistance information message associated with a sidelink DRX configuration for communications between the first UE and a second UE. The operations of 2205 may be performed in accordance with examples as disclosed herein. In some examples, aspects of the operations of 2205 may be performed by an assistance information receiving component 1325 as described with reference to FIG. 13.

At 2210, the method may include receiving, at a CU, the first assistance information message relayed by the first DU to the CU. The operations of 2210 may be performed in accordance with examples as disclosed herein. In some examples, aspects of the operations of 2210 may be performed by a CU-DU communication component 1340 as described with reference to FIG. 13.

At 2215, the method may include communicating, between the CU and at least the first DU, an indication of the sidelink DRX configuration for the first UE and an indication of a first access link DRX configuration for the first UE. The operations of 2215 may be performed in accordance with examples as disclosed herein. In some examples, aspects of the operations of 2215 may be performed by a CU-DU communication component 1340 as described with reference to FIG. 13.

At 2220, the method may include transmitting, to the first UE, the indication of the sidelink DRX configuration and the indication of the first access link DRX configuration based on the communicating. The operations of 2220 may be performed in accordance with examples as disclosed herein. In some examples, aspects of the operations of 2220 may be performed by a DRX configuration signaling component 1335 as described with reference to FIG. 13.

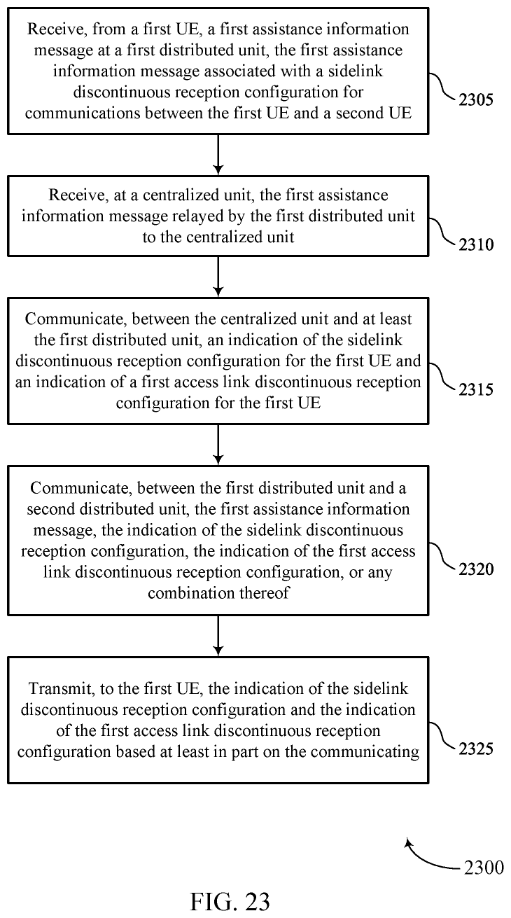

FIG. 23 shows a flowchart illustrating a method 2300 that supports coordination during access link DRX and sidelink alignment in accordance with aspects of the present disclosure. The operations of the method 2300 may be implemented by a base station or its components as described herein. For example, the operations of the method 2300 may be performed by a base station 105 as described with reference to FIGS. 1 through 14. In some examples, a base station may execute a set of instructions to control the functional elements of the base station to perform the described functions. Additionally or alternatively, the base station may perform aspects of the described functions using special-purpose hardware.

At 2305, the method may include receiving, from a first UE, a first assistance information message at a first DU, the first assistance information message associated with a sidelink DRX configuration for communications between the first UE and a second UE. The operations of 2305 may be performed in accordance with examples as disclosed herein. In some examples, aspects of the operations of 2305 may be performed by an assistance information receiving component 1325 as described with reference to FIG. 13.

At 2310, the method may include receiving, at a CU, the first assistance information message relayed by the first DU to the CU. The operations of 2310 may be performed in accordance with examples as disclosed herein. In some examples, aspects of the operations of 2310 may be performed by a CU-DU communication component 1340 as described with reference to FIG. 13.

At 2315, the method may include communicating, between the CU and at least the first DU, an indication of the sidelink DRX configuration for the first UE and an indication of a first access link DRX configuration for the first UE. The operations of 2315 may be performed in accordance with examples as disclosed herein. In some examples, aspects of the operations of 2315 may be performed by a CU-DU communication component 1340 as described with reference to FIG. 13.

At 2320, the method may include communicating, between the first DU and a second DU, the first assistance information message, the indication of the sidelink DRX configuration, the indication of the first access link DRX configuration, or any combination thereof. The operations of 2320 may be performed in accordance with examples as disclosed herein. In some examples, aspects of the operations of 2320 may be performed by a DU-DU communication component 1360 as described with reference to FIG. 13.

At 2325, the method may include transmitting, to the first UE, the indication of the sidelink DRX configuration and the indication of the first access link DRX configuration based on the communicating. The operations of 2325 may be performed in accordance with examples as disclosed herein. In some examples, aspects of the operations of 2325 may be performed by a DRX configuration signaling component 1335 as described with reference to FIG. 13.

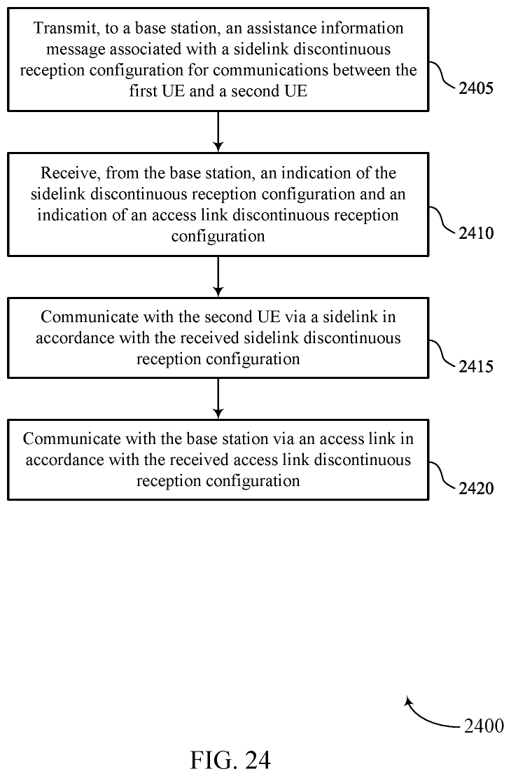

FIG. 24 shows a flowchart illustrating a method 2400 that supports coordination during access link DRX and sidelink alignment in accordance with aspects of the present disclosure. The operations of the method 2400 may be implemented by a UE or its components as described herein. For example, the operations of the method 2400 may be performed by a UE 115 as described with reference to FIGS. 1 through 10 and 15 through 18. In some examples, a UE may execute a set of instructions to control the functional elements of the UE to perform the described functions. Additionally or alternatively, the UE may perform aspects of the described functions using special-purpose hardware.

At 2405, the method may include transmitting, to a base station, an assistance information message associated with a sidelink DRX configuration for communications between the first UE and a second UE. The operations of 2405 may be performed in accordance with examples as disclosed herein. In some examples, aspects of the operations of 2405 may be performed by an assistance information transmitting component 1725 as described with reference to FIG. 17.

At 2410, the method may include receiving, from the base station, an indication of the sidelink DRX configuration and an indication of an access link DRX configuration. The operations of 2410 may be performed in accordance with examples as disclosed herein. In some examples, aspects of the operations of 2410 may be performed by a DRX configuration receiving component 1730 as described with reference to FIG. 17.

At 2415, the method may include communicating with the second UE via a sidelink in accordance with the received sidelink DRX configuration. The operations of 2415 may be performed in accordance with examples as disclosed herein. In some examples, aspects of the operations of 2415 may be performed by a sidelink communication component 1735 as described with reference to FIG. 17.

At 2420, the method may include communicating with the base station via an access link in accordance with the received access link DRX configuration. The operations of 2420 may be performed in accordance with examples as disclosed herein. In some examples, aspects of the operations of 2420 may be performed by an access link communication component 1740 as described with reference to FIG. 17.

The following provides an overview of aspects of the present disclosure:

Aspect 1: A method for wireless communication at a first base station, comprising: receiving, from a first UE, an assistance information message associated with a sidelink DRX configuration for communications between the first UE and a second UE; transmitting, to a second base station, the assistance information message received from the first UE; communicating, with the second base station via an interface between the first base station and the second base station, an indication of the sidelink DRX configuration for the first UE; and transmitting, to the first UE, an indication of the sidelink DRX configuration and an indication of an access link DRX configuration for the first UE based at least in part on the communicating.

Aspect 2: The method of aspect 1, wherein communicating with the second base station via the interface further comprises: transmitting the assistance information message between the first base station and the second base station via a connection between a first CU of the first base station and a second CU of the second base station.

Aspect 3: The method of any of aspects 1 through 2, further comprising: relaying the indication of the sidelink DRX configuration and the indication of the access link DRX configuration from a first CU of the first base station to a first DU of the first base station; and transmitting, to the first UE, the indication of the sidelink DRX configuration and the indication of the access link DRX configuration via an access link between the first UE and the first DU.

Aspect 4: The method of any of aspects 1 through 3, further comprising: transmitting the assistance information message to the second base station, the assistance information message comprising a field including one or more additional sidelink DRX configurations associated with one or more additional sidelink UEs, and a field including the indication of the access link DRX configuration for the first UE.

Aspect 5: The method of any of aspects 1 through 4, wherein the sidelink DRX configuration for the first UE comprises one or more sidelink DRX alignment parameters.

Aspect 6: The method of any of aspects 1 through 5, wherein the access link DRX configuration for the second UE comprises one or more access link DRX alignment parameters.

Aspect 7: A method for wireless communication at a second base station, comprising: receiving, from a first base station, an assistance information message from a first UE, the assistance information message for determining a sidelink DRX configuration for communications between the first UE and a second UE; transmitting, to the first base station, an indication of the sidelink DRX configuration determined for the first UE via an interface between the first base station and the second base station; and transmitting, to the second UE, an indication of an access link DRX configuration for communications between the second UE and the second base station.

Aspect 8: The method of aspect 7, wherein communicating with the first base station via the interface further comprises: receiving the assistance information message from the first base station via a connection between a first CU of the first base station and a second CU of the second base station.

Aspect 9: The method of any of aspects 7 through 8, further comprising: determining the sidelink DRX configuration for the first UE and the access link DRX configuration for the second UE; and transmitting, to the first base station, the indication of the sidelink DRX configuration for the first UE via the interface between the second base station and the first base station; and transmitting, to the second UE, the indication of the access link DRX configuration for the second UE based at least in part on the determining.

Aspect 10: The method of any of aspects 7 through 9, further comprising: receiving the assistance information message from the first base station, the assistance information message comprising a field including one or more additional sidelink DRX configurations associated with one or more additional sidelink UEs, and a field including the indication of the access link DRX configuration for the first UE.

Aspect 11: The method of any of aspects 7 through 10, wherein the sidelink DRX configuration for the first UE comprises one or more sidelink DRX alignment parameters.

Aspect 12: The method of any of aspects 7 through 11, wherein the access link DRX configuration for the second UE comprises one or more access link DRX alignment parameters.

Aspect 13: A method for wireless communication, comprising: receiving, from a first UE, a first assistance information message at a first DU, the first assistance information message associated with a sidelink DRX configuration for communications between the first UE and a second UE; receiving, at a CU, the first assistance information message relayed by the first DU to the CU; communicating, between the CU and at least the first DU, an indication of the sidelink DRX configuration for the first UE and an indication of a first access link DRX configuration for the first UE; and transmitting, to the first UE, the indication of the sidelink DRX configuration and the indication of the first access link DRX configuration based at least in part on the communicating.

Aspect 14: The method of aspect 13, further comprising: receiving, from the second UE, a second assistance information message at a second DU; receiving, at the CU, the second assistance information message relayed by the second DU to the CU; communicating, between the CU and the second DU, an indication of a second access link DRX configuration for the second UE; and transmitting, to the second UE, the indication of the first access link DRX configuration based at least in part on the communicating.

Aspect 15: The method of any of aspects 13 through 14, further comprising: receiving, at the first DU and a second DU, one or more pre-configurations for determining one or more DRX configurations for the first UE and the second UE; transmitting, to the first UE via the first DU, the indication of the sidelink DRX configuration and the indication of the first access link DRX configuration based at least in part on the one or more pre-configurations; and transmitting, to the second UE via the second DU, an indication of a second access link DRX configuration based at least in part on the one or more pre-configurations.

Aspect 16: The method of aspect 15, further comprising: communicating, between the first DU and the second DU, the one or more DRX configurations for the first UE and the second UE based at least in part on the one or more pre-configurations.

Aspect 17: The method of any of aspects 13 through 16, further comprising: communicating, between the first DU and a second DU, the first assistance information message, the indication of the sidelink DRX configuration, the indication of the first access link DRX configuration, or any combination thereof.

Aspect 18: The method of any of aspects 13 through 17, wherein the CU determines the sidelink DRX configuration for the first UE, the first access link DRX configuration for the first UE, and the second access link DRX configuration for the second UE.

Aspect 19: The method of any of aspects 13 through 18, further comprising: receiving, from the second UE, a second assistance information message at the first DU; receiving, at the CU, the second assistance information message relayed by the first DU to the CU; communicating, between the CU and the first DU, an indication of a second access link DRX configuration for the second UE; and transmitting, to the second UE, the indication of the first access link DRX configuration based at least in part on the communicating.

Aspect 20: The method of aspect 19, further comprising: receiving, at the first DU, one or more pre-configurations for determining one or more DRX configurations for the first UE and the second UE; transmitting, to the first UE via the first DU, the indication of the sidelink DRX configuration and the indication of the first access link DRX configuration based at least in part on the one or more pre-configurations; and transmitting, to the second UE via the first DU, an indication of a second access link DRX configuration based at least in part on the one or more pre-configurations.

Aspect 21: The method of aspect 20, further comprising: communicating, between the CU and the first DU, the one or more DRX configurations for the first UE and the second UE based at least in part on the one or more pre-configurations.

Aspect 22: The method of any of aspects 13 through 21, further comprising: communicating, between the CU and the first DU and a second DU, the first assistance information message, the indication of the sidelink DRX configuration, the indication of the first access link DRX configuration, or any combination thereof.

Aspect 23: The method of any of aspects 13 through 22, wherein the first assistance information message comprises one or more additional indications of sidelink connected mode DRX configurations established between the first UE and one or more other sidelink UEs.

Aspect 24: The method of any of aspects 13 through 23, further comprising: communicating via layer-1 signaling, layer-2 signaling, layer-3 signaling, or any combination thereof.

Aspect 25: A method for wireless communication at a first UE, comprising: transmitting, to a base station, an assistance information message associated with a sidelink DRX configuration for communications between the first UE and a second UE; receiving, from the base station, an indication of the sidelink DRX configuration and an indication of an access link DRX configuration; communicating with the second UE via a sidelink in accordance with the received sidelink DRX configuration; and communicating with the base station via an access link in accordance with the received access link DRX configuration.

Aspect 26: The method of aspect 25, further comprising: receiving, via a first DU of the base station, the indication of the sidelink DRX configuration and the indication of the access link DRX configuration based at least in part on one or more pre-configurations.

Aspect 27: The method of any of aspects 25 through 26, wherein transmitting the assistance information message further comprises: transmitting the assistance information message via the access link to a first DU of the base station.

Aspect 28: The method of any of aspects 25 through 27, wherein the assistance information message comprises one or more additional indications of sidelink connected mode DRX configurations established between the first UE and one or more other sidelink UEs.

Aspect 29: The method of any of aspects 25 through 28, further comprising: communicating via layer-1 signaling, layer-2 signaling, layer-3 signaling, or any combination thereof.

Aspect 30: The method of any of aspects 25 through 29, further comprising: refraining from transmitting the sidelink DRX configuration to the second UE based at least in part on receiving the indication of the sidelink DRX configuration from the base station.

Aspect 31: An apparatus for wireless communication at a first base station, comprising a processor; memory coupled with the processor; and instructions stored in the memory and executable by the processor to cause the apparatus to perform a method of any of aspects 1 through 6.

Aspect 32: An apparatus for wireless communication at a first base station, comprising at least one means for performing a method of any of aspects 1 through 6.

Aspect 33: A non-transitory computer-readable medium storing code for wireless communication at a first base station, the code comprising instructions executable by a processor to perform a method of any of aspects 1 through 6.

Aspect 34: An apparatus for wireless communication at a second base station, comprising a processor; memory coupled with the processor; and instructions stored in the memory and executable by the processor to cause the apparatus to perform a method of any of aspects 7 through 12.

Aspect 35: An apparatus for wireless communication at a second base station, comprising at least one means for performing a method of any of aspects 7 through 12.

Aspect 36: A non-transitory computer-readable medium storing code for wireless communication at a second base station, the code comprising instructions executable by a processor to perform a method of any of aspects 7 through 12.

Aspect 37: An apparatus for wireless communication, comprising a processor; memory coupled with the processor; and instructions stored in the memory and executable by the processor to cause the apparatus to perform a method of any of aspects 13 through 24.

Aspect 38: An apparatus for wireless communication, comprising at least one means for performing a method of any of aspects 13 through 24.

Aspect 39: A non-transitory computer-readable medium storing code for wireless communication, the code comprising instructions executable by a processor to perform a method of any of aspects 13 through 24.

Aspect 40: An apparatus for wireless communication at a first UE, comprising a processor; memory coupled with the processor; and instructions stored in the memory and executable by the processor to cause the apparatus to perform a method of any of aspects 25 through 30.

Aspect 41: An apparatus for wireless communication at a first UE, comprising at least one means for performing a method of any of aspects 25 through 30.

Aspect 42: A non-transitory computer-readable medium storing code for wireless communication at a first UE, the code comprising instructions executable by a processor to perform a method of any of aspects 25 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first base station, comprising:
receiving, from a first user equipment (UE), an assistance information message associated with a sidelink discontinuous reception configuration for communications between the first UE and a second UE;
transmitting, to a second base station, the assistance information message received from the first UE;
communicating, with the second base station via an interface between the first base station and the second base station, an indication of the sidelink discontinuous reception configuration for the first UE; and
transmitting, to the first UE, an indication of the sidelink discontinuous reception configuration and an indication of an access link discontinuous reception configuration for the first UE based at least in part on the communicating.

2. The method of claim 1, wherein communicating with the second base station via the interface further comprises:
transmitting the assistance information message between the first base station and the second base station via a connection between a first centralized unit of the first base station and a second centralized unit of the second base station.

3. The method of claim 1, further comprising:
relaying the indication of the sidelink discontinuous reception configuration and the indication of the access link discontinuous reception configuration from a first centralized unit of the first base station to a first distributed unit of the first base station; and
transmitting, to the first UE, the indication of the sidelink discontinuous reception configuration and the indication of the access link discontinuous reception configuration via an access link between the first UE and the first distributed unit.

4. The method of claim 1, further comprising:
transmitting the assistance information message to the second base station, the assistance information message comprising a field including one or more additional sidelink discontinuous reception configurations associated with one or more additional sidelink UEs, and a field including the indication of the access link discontinuous reception configuration for the first UE.

5. The method of claim 1, wherein the sidelink discontinuous reception configuration for the first UE comprises one or more sidelink discontinuous reception alignment parameters.

6. The method of claim 1, wherein the access link discontinuous reception configuration for the second UE comprises one or more access link discontinuous reception alignment parameters.

7. A method for wireless communication at a second base station, comprising:
receiving, from a first base station, an assistance information message from a first user equipment (UE), the assistance information message for determining a sidelink discontinuous reception configuration for communications between the first UE and a second UE;
transmitting, to the first base station, an indication of the sidelink discontinuous reception configuration determined for the first UE via an interface between the first base station and the second base station; and
transmitting, to the second UE, an indication of an access link discontinuous reception configuration for communications between the second UE and the second base station.

8. The method of claim 7, wherein communicating with the first base station via the interface further comprises:
receiving the assistance information message from the first base station via a connection between a first centralized unit of the first base station and a second centralized unit of the second base station.

9. The method of claim 7, further comprising:
determining the sidelink discontinuous reception configuration for the first UE and the access link discontinuous reception configuration for the second UE; and
transmitting, to the first base station, the indication of the sidelink discontinuous reception configuration for the first UE via the interface between the second base station and the first base station; and
transmitting, to the second UE, the indication of the access link discontinuous reception configuration for the second UE based at least in part on the determining.

10. The method of claim 7, further comprising:
receiving the assistance information message from the first base station, the assistance information message comprising a field including one or more additional sidelink discontinuous reception configurations associated with one or more additional sidelink UEs, and a field including the indication of the access link discontinuous reception configuration for the first UE.

11. The method of claim 7, wherein the sidelink discontinuous reception configuration for the first UE comprises one or more sidelink discontinuous reception alignment parameters.

12. The method of claim 7, wherein the access link discontinuous reception configuration for the second UE comprises one or more access link discontinuous reception alignment parameters.

13. A method for wireless communication, comprising:
receiving, from a first user equipment (UE), a first assistance information message at a first distributed unit, the first assistance information message associated with a sidelink discontinuous reception configuration for communications between the first UE and a second UE;
receiving, at a centralized unit, the first assistance information message relayed by the first distributed unit to the centralized unit;
communicating, between the centralized unit and at least the first distributed unit, an indication of the sidelink discontinuous reception configuration for the first UE and an indication of a first access link discontinuous reception configuration for the first UE; and
transmitting, to the first UE, the indication of the sidelink discontinuous reception configuration and the indication of the first access link discontinuous reception configuration based at least in part on the communicating.

14. The method of claim 13, further comprising:
receiving, from the second UE, a second assistance information message at a second distributed unit;
receiving, at the centralized unit, the second assistance information message relayed by the second distributed unit to the centralized unit;
communicating, between the centralized unit and the second distributed unit, an indication of a second access link discontinuous reception configuration for the second UE; and
transmitting, to the second UE, the indication of the first access link discontinuous reception configuration based at least in part on the communicating.

15. The method of claim 13, further comprising:
receiving, at the first distributed unit and a second distributed unit, one or more pre-configurations for determining one or more discontinuous reception configurations for the first UE and the second UE;
transmitting, to the first UE via the first distributed unit, the indication of the sidelink discontinuous reception configuration and the indication of the first access link discontinuous reception configuration based at least in part on the one or more pre-configurations; and
transmitting, to the second UE via the second distributed unit, an indication of a second access link discontinuous reception configuration based at least in part on the one or more pre-configurations.

16. The method of claim 15, further comprising:
communicating, between the first distributed unit and the second distributed unit, the one or more discontinuous reception configurations for the first UE and the second UE based at least in part on the one or more pre-configurations.

17. The method of claim 13, further comprising:
communicating, between the first distributed unit and a second distributed unit, the first assistance information message, the indication of the sidelink discontinuous reception configuration, the indication of the first access link discontinuous reception configuration, or any combination thereof.

18. The method of claim 13, wherein the centralized unit determines the sidelink discontinuous reception configuration for the first UE, the first access link discontinuous reception configuration for the first UE, and the second access link discontinuous reception configuration for the second UE.

19. The method of claim 13, further comprising:
receiving, from the second UE, a second assistance information message at the first distributed unit;
receiving, at the centralized unit, the second assistance information message relayed by the first distributed unit to the centralized unit;
communicating, between the centralized unit and the first distributed unit, an indication of a second access link discontinuous reception configuration for the second UE; and
transmitting, to the second UE, the indication of the first access link discontinuous reception configuration based at least in part on the communicating.

20. The method of claim 19, further comprising:
receiving, at the first distributed unit, one or more pre-configurations for determining one or more discontinuous reception configurations for the first UE and the second UE;
transmitting, to the first UE via the first distributed unit, the indication of the sidelink discontinuous reception configuration and the indication of the first access link discontinuous reception configuration based at least in part on the one or more pre-configurations; and
transmitting, to the second UE via the first distributed unit, an indication of a second access link discontinuous reception configuration based at least in part on the one or more pre-configurations.

21. The method of claim 20, further comprising:
communicating, between the centralized unit and the first distributed unit, the one or more discontinuous reception configurations for the first UE and the second UE based at least in part on the one or more pre-configurations.

22. The method of claim 13, further comprising:
communicating, between the centralized unit and the first distributed unit and a second distributed unit, the first assistance information message, the indication of the sidelink discontinuous reception configuration, the indication of the first access link discontinuous reception configuration, or any combination thereof.

23. The method of claim 13, wherein the first assistance information message comprises one or more additional indications of sidelink connected mode discontinuous reception configurations established between the first UE and one or more other sidelink UEs.

24. The method of claim 13, further comprising:
communicating via layer-1 signaling, layer-2 signaling, layer-3 signaling, or any combination thereof.

25. A method for wireless communication at a first user equipment (UE), comprising:
transmitting, to a base station, an assistance information message associated with a sidelink discontinuous reception configuration for communications between the first UE and a second UE;
receiving, from the base station, an indication of the sidelink discontinuous reception configuration and an indication of an access link discontinuous reception configuration;
communicating with the second UE via a sidelink in accordance with the received sidelink discontinuous reception configuration; and
communicating with the base station via an access link in accordance with the received access link discontinuous reception configuration.

26. The method of claim 25, further comprising:
receiving, via a first distributed unit of the base station, the indication of the sidelink discontinuous reception configuration and the indication of the access link discontinuous reception configuration based at least in part on one or more pre-configurations.

27. The method of claim 25, wherein transmitting the assistance information message further comprises:
transmitting the assistance information message via the access link to a first distributed unit of the base station.

28. The method of claim 25, wherein the assistance information message comprises one or more additional indications of sidelink connected mode discontinuous reception configurations established between the first UE and one or more other sidelink UEs.

29. The method of claim 25, further comprising:
communicating via layer-1 signaling, layer-2 signaling, layer-3 signaling, or any combination thereof.

30. The method of claim 25, further comprising:
refraining from transmitting the sidelink discontinuous reception configuration to the second UE based at least in part on receiving the indication of the sidelink discontinuous reception configuration from the base station.
